(19) United States
(12) Patent Application Publication
(10) Pub. No.: US 2025/0377676 A1
(43) Pub. Date: Dec. 11, 2025

(54) HUMIDITY REDUCTION

(71) Applicant: BD KIESTRA B.V., Drachten (NL)

(72) Inventors: Martijn Rene Hegge, Lutjegast (NL); Chris Johannes Dijkstra, Niawier (NL); Hendrik Willem van der Meulen, Drachten (NL); Lukas Blaauw, Leeuwarden (NL); Siebrand Jan Albertus Dijkstra, Grootegast (NL); Remco Stadler, Vries (NL)

(73) Assignee: BD KIESTRA B.V., Drachten (NL)

(21) Appl. No.: 19/226,597

(22) Filed: Jun. 3, 2025

Related U.S. Application Data
(60) Provisional application No. 63/656,392, filed on Jun. 5, 2024.

(51) Int. Cl. G05D 22/02

(52) U.S. Cl. CPC G05D 22/02

(57) ABSTRACT

A humidity control system that is able to be retrofitted inside existing and operational enclosures, and is capable of controlling the relative humidity (RH) levels inside enclosures. The humidity control system at least includes a pneumatic valve and a humidity controller. The controller measures the RH levels inside an enclosure, and compares the measured RH with a first setpoint. When the first setpoint is reached, the controller opens the pneumatic valve, allowing dry gas to flow into the enclosure, which reduces the RH inside the enclosure. The controller maintains the state of the pneumatic valve until a second setpoint is reached. When the second setpoint is reached, the controller closes the pneumatic valve to prevent gas from flowing into the enclosure, which may increase the RH inside the enclosure. This regulating behavior causes the RH inside the enclosure to stabilize around a desired RH level setpoint.

### CROSS-REFERENCE TO RELATED APPLICATIONS

This application claims the benefit of the filing date of U.S. Provisional Patent Application No. 63/656,392 filed Jun. 5, 2024, the disclosure of which is hereby incorporated herein by reference.

### TECHNICAL FIELD

The present application relates to systems and methods for controlling the humidity levels inside heated cabinets, such as incubators used for the incubation and reading of biological cultures.

### BACKGROUND

Enclosures, such as heated cabinets may be used for various purposes. Examples of such enclosures include incubators used for the incubation and reading of biological cultures; food warming cabinets used to keep cooked food warm before serving; industrial heating cabinets used in industrial settings for various purposes such as drying coatings, curing adhesives, warming materials before processing, or maintaining consistent temperatures for specific manufacturing processes; moisture control cabinets used to maintain low humidity levels and prevent moisture-related damage to sensitive components or materials, such as electronics manufacturing or storage facilities; medical instrument sterilization cabinets used for sterilizing instruments and equipment by achieving and maintaining the necessary sterilization temperatures; controlled atmosphere cabinets used as part of glove boxes or controlled atmosphere chambers to help maintain specific temperature conditions inside the controlled environment; paint drying cabinets used to accelerate the drying process of painted parts or coatings, ensuring faster turnaround times for projects; curing ovens used to cure various materials applied during semiconductor manufacturing processes, such as photoresist materials used in photolithography processes; annealing ovens used for annealing processes, which involve heating semiconductor materials to specific temperatures to induce changes in their properties, such as to relieve internal stresses, improve crystal structure, and/or activate dopants in semiconductor devices; among many other types of enclosures or heated cabinets.

Typically, heated cabinets are insulated boxes that work by controlling a number of environmental factors, including temperature and humidity to provide a desired environment. For example, in incubators used to promote the formation of microorganism cultures if such microorganisms are present in biological samples, the desired environment is one suitable to maintain sample viability and/or to support microbial growth. Incubators also have features that control the composition of the atmosphere in the incubator, such as the amount of carbon dioxide (CO₂) and/or oxygen (O₂) in the incubator environment.

One problem with many heated cabinets is the difficulty in maintaining the controlled atmosphere within the heated cabinets. For example, depending on the contents contained within a heated cabinet, the relative humidity (RH) within the heated cabinet may increase to a point where the air is saturated (i.e., ˜100% RH), which may result in excess condensation building up inside the heated cabinet. However, while most heated cabinets include temperature controllers (e.g., thermostats) to control the ambient temperature inside the heated cabinets, most heated cabinets do not include dedicated humidity control mechanisms to control the RH within the heated cabinets. Such excess condensation inside an enclosure can cause contamination and/or application-specific issues.

### BRIEF SUMMARY

The present disclosure addresses the aforementioned issues by providing a humidity control system that is able to be retrofitted inside existing and operational enclosures, such as incubators. Inside such enclosures, there is a balance between the amount of moisture added to the enclosure and the amount of moisture escaping from the enclosed space. The moisture may enter the enclosure through airflow into the enclosure and/or from the contents enclosed in the enclosure. For example, an incubator may include a number of agar plates with a relatively high water content, and water from the agar plates may evaporate when the incubator is heated, thereby filling the incubator atmosphere with moist air. Theoretically, this process continues until the air inside the enclosure is saturated (e.g., ˜100% RH). Moisture also leaves the enclosure through the refreshment of air, since many enclosures are not fully airtight. Upon leaving the enclosure, the moisture can condense when the moist air comes in contact with cooler surfaces. Such condensate is not desirable, and can contaminate the lab environment in which the incubator is located. Also, the refreshment of air is a limited solution to the problem, and it varies depending on, for example, enclosure type and design.

The humidity control system described herein is able to reduce the RH levels inside enclosures by blowing dry and filtered compressed air (or other gas) into such enclosures when the RH level becomes too high. The humidity control system at least includes a pneumatic valve and a self-contained, configurable humidity controller, such as a hygrostat or hygrotherm. The humidity controller measures the humidity levels inside an enclosure, such as an incubator. The humidity controller compares the RH inside the enclosure with a configured setpoint. When the setpoint is reached, the humidity controller switches (e.g., opens) the pneumatic valve. The humidity controller may control a relay that opens the pneumatic valve or otherwise causes the valve closure element to permit the flow of gas into the enclosure. The pneumatic valve controls the flow of air into the enclosure. Opening the pneumatic valve causes the gas to blow or flow into the enclosure. The humidity controller continuously or periodically measures the RH inside the enclosure. The humidity controller maintains the state of the pneumatic valve until a configured hysteresis setpoint is reached. When the hysteresis setpoint is reached, the humidity controller switches the pneumatic valve off or otherwise causes the valve closure element to prevent gas from flowing into the enclosure. This regulating behavior causes the humidity level to stabilize around the setpoint.

The pneumatic valve, and potentially other pneumatic components, direct the gas toward a heating element that heats/warms up the enclosure. The gas may be guided to the front of the heating element to avoid disturbances in the temperature distribution of the enclosure.

The enclosure in which the humidity control system is deployed may include one or more fans to circulate the air inside the enclosure. In these implementations, the fresh and moist gas may mix evenly because the air inside the enclosure is circulated by the one or more fans.

The gas that flows into the enclosure may be compressed air, CO₂, and/or some other gas. In some examples, the gas is supplied by a compressor according to ISO 8573-1:2010 [4:4:4]. Additionally or alternatively, the gas may be filtered in accordance with ISO 8573-1:2010 [1:7:2] before being released into the enclosure. In other examples, the gas is supplied by a compressor according to ISO 8573-1:2010 [1:7:2].

In some examples, the humidity control system is mounted inside the enclosure. In some examples, the enclosure is an incubator cabinet for incubating inoculated samples.

Exemplary embodiments include a humidity control system that is adapted to, or configured to, be deployed in an enclosure. The humidity control system includes a pneumatic valve and a humidity controller. The pneumatic valve may be pneumatically connected to an interior of the enclosure. The humidity controller may be electrically connected to the pneumatic valve. The humidity controller may be configured to receive sensor data representative of a measured RH level inside the enclosure; cause the pneumatic valve to allow gas to flow into the enclosure when the measured RH level is above a configured setpoint; and cause the pneumatic valve to prevent gas from flowing into the enclosure when the measured RH level is below the configured setpoint.

In some embodiments, the pneumatic valve may be pneumatically connected to an interior of the enclosure via a first pneumatic connection. The first pneumatic connection may include a flow control device and a pneumatic tube. The pneumatic valve may be directly coupled with the flow control device via a first connector of the flow control device. The flow control device may be directly coupled with a first end of the pneumatic tube via a second connector of the flow control device. In some embodiments, the first connector of the flow control device is a male fastener configured to be received by a first female port of the pneumatic valve, and the second connector of the flow control device is a female port configured to receive a male connector on the end of the pneumatic tube.

In some embodiments, a second end of the pneumatic tube may be connected to a pneumatic fitting. In some embodiments, the pneumatic fitting is an L-shaped connector or a J-shaped connector. Additionally or alternatively, the pneumatic fitting has a tubular or cylindrical shape. A first port of the pneumatic fitting may be connected to the second end of the pneumatic tube. A second port of the pneumatic fitting may be connected to a pneumatic silencer. The second end of the pneumatic tube may be aimed at a heating element inside the enclosure such that the gas flowing into the enclosure is directed towards the heating element to provide a drying effect. Additionally or alternatively, the second end of the pneumatic tube may be aimed at one or more fans inside the enclosure such that the gas flowing into the enclosure is directed towards the one or more fans to circulate the gas throughout an interior of the enclosure.

In some embodiments, the pneumatic valve may be pneumatically connected to a gas source via a second pneumatic connection. The second pneumatic connection may include an air coupling and a second pneumatic tube, where the aforementioned pneumatic tube is a first pneumatic tube. The pneumatic valve may be directly coupled with the air coupling via a first connector of the air coupling. Additionally or alternatively, the air coupling may be directly coupled with a first end of the second pneumatic tube via a second connector of the air coupling.

In some embodiments, the first connector of the air coupling is a male fastener configured to be received by a second female port of the pneumatic valve, and the second connector of the air coupling is a female port configured to receive a male connector on the first end of the second pneumatic tube. Additionally or alternatively, the air coupling is an L-shaped connector or a J-shaped connector. Additionally or alternatively, the air coupling has a tubular or cylindrical shape.

A second end of the second pneumatic tube may be connected to another pneumatic fitting. A first connector of the other pneumatic fitting may be connected to the second end of the second pneumatic tube, and a second port of the other pneumatic fitting may be connected to the gas source. In some embodiments, the other pneumatic fitting is a Y-shaped connector. Additionally or alternatively, the other pneumatic fitting has a tubular or cylindrical shape. The other pneumatic fitting may be connected to the gas source via a third pneumatic tube. A third port of the other pneumatic fitting may be connected one or more pneumatic actuators via a fourth pneumatic tube. In some embodiments, the one or more pneumatic actuators are configured to move an XYR manipulator

In some embodiments, the gas source may include a compressor and a gas tank or cylinder. In one example, the compressor is an air compressor. The compressor may be configured to supply air according to ISO 8573-1:2010 [4:4:4] or ISO 8573-1:2010 [1:7:2]. The gas tank or cylinder may store, or otherwise include, at least one gas selected from a group comprising: air, oxygen, carbon dioxide, nitrogen, argon, helium, hydrogen, or a specialty gas. In other embodiments, the gas source may be an external gas supply line.

In some embodiments, the humidity controller may be configured to cause the pneumatic valve to allow gas to flow into the enclosure only when the measured RH level is greater than the configured setpoint plus a hysteresis value. Additionally or alternatively, the humidity controller may be configured to cause the pneumatic valve to prevent gas from flowing into the enclosure when the measured RH level is below the configured setpoint minus a hysteresis value. Additionally or alternatively, the humidity controller may be configured to configure the setpoint by continuous reduction of the setpoint by a value until the effects of excess humidity are no longer observed within the enclosure.

In some embodiments, the humidity controller may be configured to receive the sensor data representative of the measured RH level from one or more humidity sensors inside the enclosure. In some embodiments, at least one of the one or more humidity sensors is embedded in the humidity controller. Additionally or alternatively, at least one of the one or more humidity sensors are external to the humidity controller and mounted inside the enclosure separate from the humidity controller. Additionally or alternatively, the humidity controller may be configured to receive other sensor data from one or more other sensors inside the enclosure and/or outside the enclosure. In some embodiments, the other sensor data may be representative of the measured RH level inside the enclosure. Additionally or alternatively, the other sensor data may be representative of another type of measurement, and the humidity controller may be configured to convert the other type of measurement into an RH level. Examples of the other sensors may include image sensors or cameras, infrared sensors, dew point sensors, conductive condensation sensors, thermal conductivity sensors, and/or any other type of sensor or device capable of detecting moisture and/or condensation.

In some embodiments, the humidity controller may be configured to determine the setpoint based on the measured RH level inside the enclosure and a desired moisture abatement. Additionally or alternatively, the humidity controller may be configured to configure or set the setpoint by continuous reduction of the setpoint by a predetermined or configured value until the desired moisture abatement is observed within the enclosure. The humidity controller may be configured to observe the desired moisture abatement based on the sensor data received from the one or more humidity sensors and/or the other sensor data received from the one or more other sensors.

In some embodiments, the pneumatic valve includes a valve closure element. The humidity control system may be configured to cause the pneumatic valve to allow gas to flow into the enclosure. In this regard, the humidity controller may be configured to send a signal to the pneumatic valve to open the valve closure element. The humidity control system may be configured to cause the pneumatic valve to prevent gas from flowing into the enclosure. In this regard, the humidity controller may be configured to send a signal to the pneumatic valve to close the valve closure element.

In some embodiments, the humidity controller is a hygrostat or a hygrotherm. Additionally or alternatively, the humidity controller comprises a special-purpose processor that is tailored or designed to monitor RH inside enclosures and control pneumatic components to regulate the RH inside such enclosures.

In some embodiments, the humidity control system may be adapted to, or configured to, be deployed inside an enclosure. In this regard, the humidity control system may include a bracket on which the pneumatic valve and the humidity controller are configured to be mounted. In some embodiments, an arrangement of the humidity control system may include the humidity controller being positioned below the pneumatic valve when the pneumatic valve and the humidity controller are mounted on the bracket. The bracket may be adapted to, or configured to, be mounted on an inside wall of the enclosure. The enclosure may be, for example, an incubator, a food warming cabinet, an industrial heating cabinet, a moisture control cabinet, medical instrument sterilization cabinet, a controlled atmosphere chamber, a glove box, a paint drying cabinet, a curing oven used for semiconductor manufacturing, or an annealing oven used for semiconductor manufacturing.

Example embodiments include a method of operating a humidity controller that is part of a humidity control system deployed in an enclosure. The humidity control system may also include a pneumatic valve connected to the humidity controller. In some examples, the pneumatic valve may be pneumatically connected to an interior of the enclosure. The method may include receiving sensor data from at least one humidity sensor. The sensor data may be representative of a measured and/or recorded relative humidity (RH) level inside the enclosure. The method may include causing the pneumatic valve to allow gas to flow into the enclosure when the measured RH level is above a configured setpoint. The method may include causing the pneumatic valve to prevent gas from flowing into the enclosure when the measured RH level is below the configured setpoint.

The method may include causing the pneumatic valve to allow gas to flow into the enclosure only when the measured RH level is greater than the configured setpoint plus a first hysteresis value. Additionally or alternatively, the method may include causing the pneumatic valve to prevent gas from flowing into the enclosure when the measured RH level is below the configured setpoint minus a second hysteresis value. In some embodiments, the first hysteresis value is same as the second hysteresis value. In some embodiments, the first hysteresis value is different than the second hysteresis value.

The method may include sending a first signal to the pneumatic valve to cause the pneumatic valve to allow gas to flow into the enclosure. The first signal may instruct, control, or otherwise cause the pneumatic valve to open the valve closure element. The method may include sending a second signal to the pneumatic valve to cause the pneumatic valve to prevent gas from flowing into the enclosure. The second signal may instruct, control, or otherwise cause the pneumatic valve to close the valve closure element.

The method may include configuring the setpoint by continuous reduction of the setpoint by a value until a desired moisture abatement is observed within the enclosure. In some embodiments, the desired moisture abatement may be observed by the at least one humidity sensor. In some embodiments, the at least one humidity sensor is embedded in the humidity controller. In other embodiments, the at least one humidity sensor is external to the humidity controller and mounted inside the enclosure separate from the humidity controller. Additionally or alternatively, other types of sensors may be used to observe the desired moisture abatement. The other types of sensors may be inside and/or outside the enclosure. Examples of these other types of sensors may include image sensors or cameras, infrared sensors, dew point sensors, conductive condensation sensors, thermal conductivity sensors, and/or any other type of sensor or device capable of detecting moisture and/or condensation. In some embodiments, the other types of sensors may be embedded in the humidity controller, mounted inside the enclosure separate from the humidity controller, and/or mounted outside the enclosure separate from the humidity controller.

Example embodiments include at least one computer-readable storage media with instructions. Execution of the instructions by one or more processors of a humidity controller may cause the humidity controller to perform the method of the example embodiments previously described, and/or any other method or process described herein.

### BRIEF DESCRIPTION OF DRAWINGS

Embodiments are illustrated by way of example, and not limitation, in the figures of the appended drawings, wherein:

FIG. 1A depicts an example integrated incubator apparatus including an incubator cabinet integrated with external conveyors, stackers, and an imaging subsystem;

FIG. 1B depicts a front view of the integrated incubator apparatus of FIG. 1A;

FIG. 1C depicts a side view of the integrated incubator apparatus of FIG. 1A;

FIG. 1D depicts views of a container storage area (CSA) within the integrated incubator apparatus of FIG. 1A;

FIG. 1E depicts a portion of the integrated incubator apparatus of FIG. 1A cut away to reveal portions of the CSA that are contained within the incubator cabinet;

FIG. 1F depicts cold spots within a portion of the integrated incubator apparatus of FIG. 1A;

FIG. 2A depicts an example humidity control subassembly that may be implemented in a heated cabinet, such as the integrated incubator apparatus of FIG. 1A;

FIG. 2B shows an exploded view of the humidity control subassembly of FIG. 2A;

FIGS. 3A and 3B depict example components of the humidity control subassembly of FIG. 2A;

FIG. 4A depicts a portion of an example incubator cabinet cut away to reveal a humidity control subassembly disposed within the incubator cabinet;

FIG. 4B depicts a portion of another example incubator cabinet cut away to reveal a humidity control subassembly disposed within the incubator cabinet;

FIG. 4C shows a side view of the humidity control system installed in an incubator cabinet;

FIG. 5A depicts example gas supply connections for the humidity control system installed in an incubator cabinet;

FIG. 5B depicts example positioning of gas outlets for the humidity control system installed in an incubator cabinet;

FIGS. 6A and 6B depict aspects related to electrical connections for the humidity control system installed in an incubator cabinet;

FIG. 7 shows an example humidity controller configuration process for configuring the humidity controller of the humidity control system;

FIG. 8 shows an example humidity control process during operation of a heated cabinet, such an incubator; and

FIG. 9 depicts an example showing the relative humidity versus time with humidity control and without humidity control.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. Furthermore, the while following detailed description primarily focuses on examples involving incubators and automated incubation systems, the embodiments, underlying principles, and functionalities discussed herein can also be applicable other types of heated cabinets used in various industries and applications.

### 1. Example Incubator Embodiments

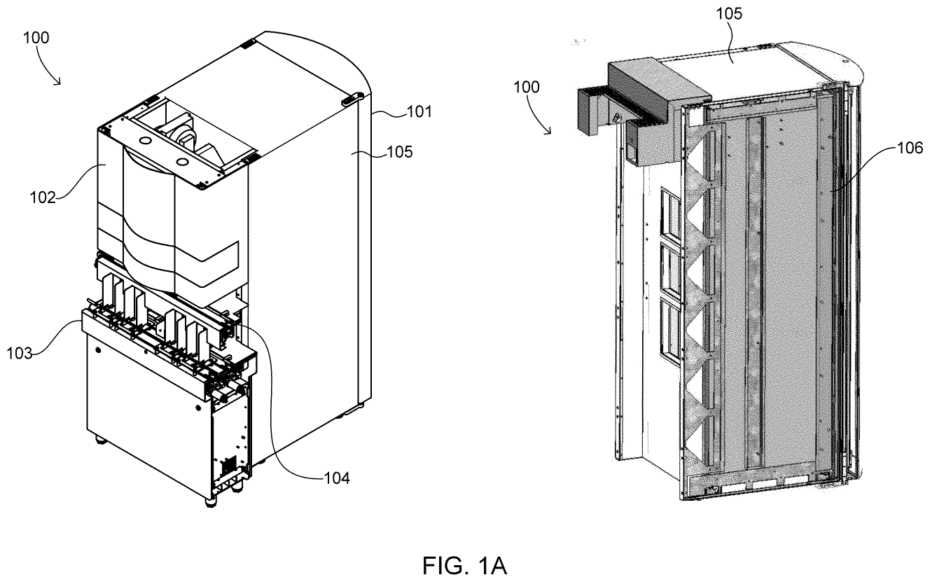

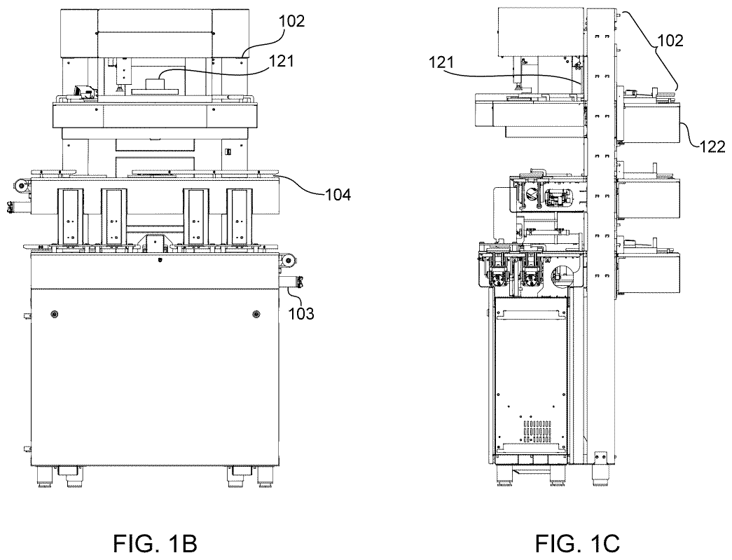

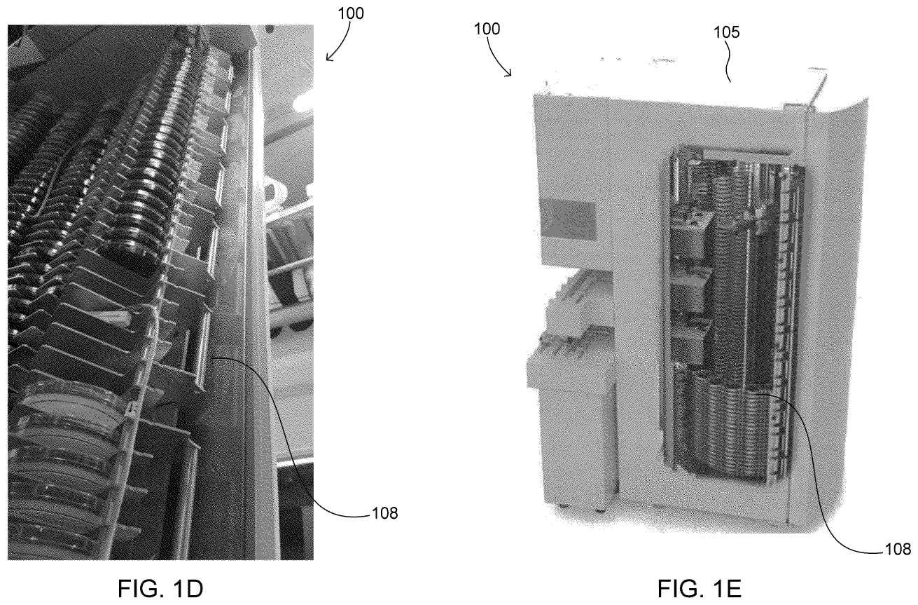

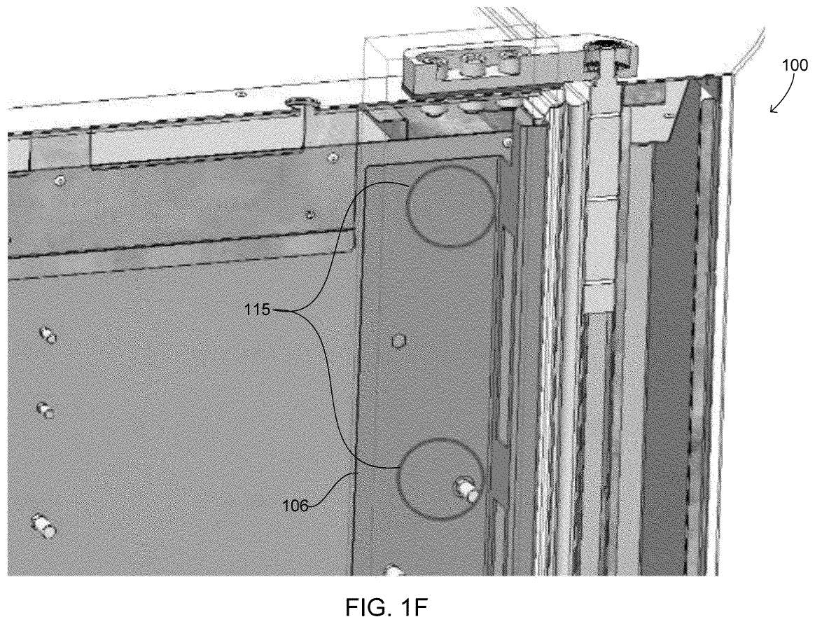

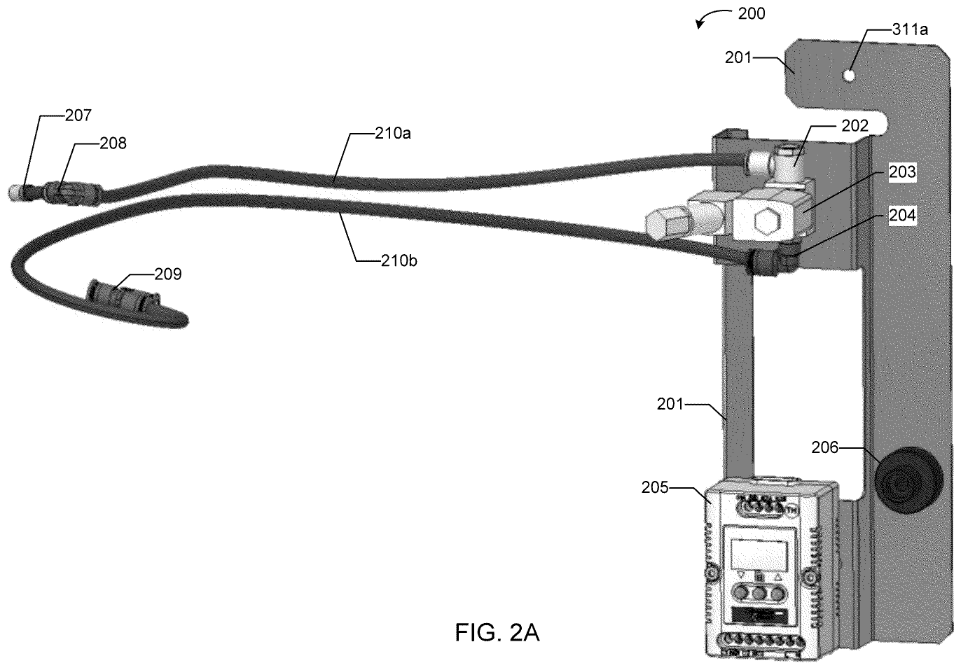

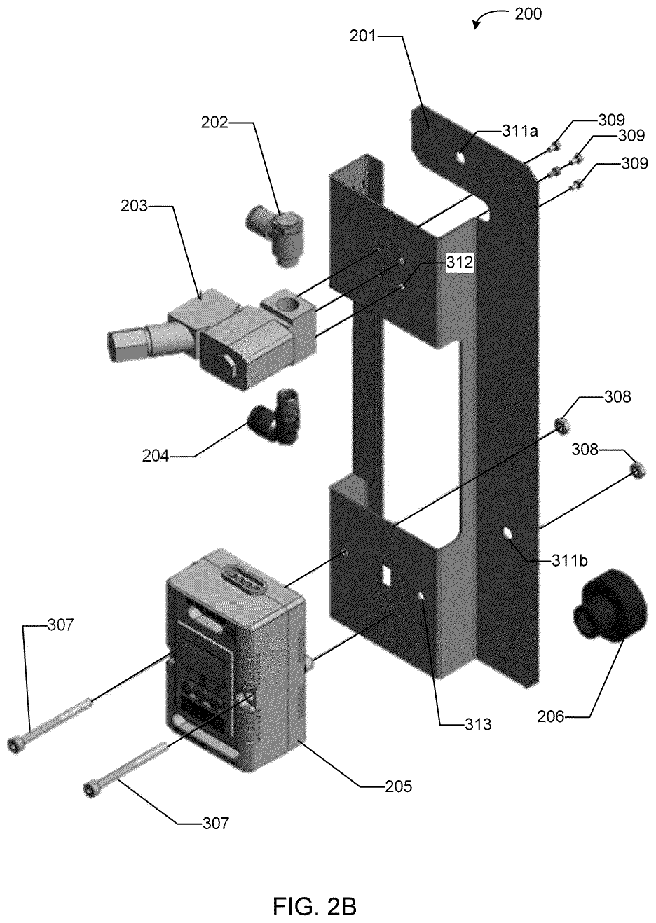

FIG. 1A illustrates perspective and side views of an example integrated incubator apparatus 100 (also referred to herein as “incubator 100”), which includes an incubator cabinet 105 integrated with external conveyors such as a first track system 103 and second track system 104, stackers, an incubator subassembly 101, and an imaging subsystem 102. A reinforcement beam, 106, is visible behind the cabinet “skin.” FIG. 1B depicts a front view of the incubator 100 with external conveyors 104 shown in the foreground. FIG. 1C depicts a side view of external conveyors and an imaging subsystem 102 with a portion of the incubator 100 cut away to reveal the portions of the conveyors that extend into the incubator cabinet. FIG. 1D shows a view of a container storage area (CSA) 108 of the incubator 100. FIG. 1E shows a portion of the incubator 100 cut away to reveal portions of the CSA 108 that are contained within the incubator cabinet. The incubator 100 is capable of being integrated into a fully automated laboratory environment, such as the automated sample container management system discussed in U.S. Pat. No. 11,041,871 filed on 15 Apr. 2015 (hereinafter “[′871]”), the contents of which is hereby incorporated by reference in its entirety and for all purposes. Such an automated sample container management system may be, for example, a BD Kiestra™ ReadA Incubator and/or BD Kiestra™ ReadA Compact Incubator as part of the BD Kiestra™ Total Lab Automation system (TLA) and BD Kiestra™ Work Cell Automation system (WCA), WASPLab® provided by Copan Diagnostics, and/or the like.

The incubator 100 is an instrument that can be used to incubate inoculated containers/plates and image the incubated containers/plates at pre-defined time points. Typically, containers that contain growth media inoculated with a sample, such as petri dishes, have a culture media that provides nutrients that support microbial growth therein. In addition to the nutrients, the media often has other additives (e.g. sodium chloride) that will provide the culture media with the correct consistency to support the growth of target microorganisms, or nutrient indicators that will indicate target microorganisms, if present in the sample. The incubator 100 may also provide a suitable environment for incubating the inoculated containers/plates. For example, the incubator 100 may operate at an ambient temperature ranging between 18 degrees Celsius (° C.) and 27° C., and operate at an ambient humidity range of between 20%-80% RH, non-condensing. By way of another example, a CO₂ incubation environment may involve a CO₂ consumption rate of less than (<) 50 liters/hour (1/hr) at 5% CO₂ concentration. By way of yet another example, the humidity may be maintained at a minimum of 60% RH in order to maintain sample integrity and/or prevent excessive dehydration of samples.

The incubator 100 includes a CSA 108 within the housing 105 for accommodating a plurality of inoculated containers. The CSA 108 includes a set of racks that allows for individual storage of plates or containers inside the incubator 100. An X-Y-R manipulator (not shown), such as a robotic arm and/or the like, picks and places plates/containers from, and to, the CSA 108. The CSA 108 may be partially cylindrical and define a virtual vertical axis. The housing 105 of the incubator cabinet may include a plurality of CSAs 108 arranged along its interior walls. In some implementations, the CSA 108 includes between 500 and 2000 positions (e.g., slots or shelving) each adapted to receive and hold an inoculated container/plate. Each position of the plurality of positions of the CSA 108 includes a coordinate representative of that position to distinguish from other positions in the CSA 108.

The aforementioned XYR manipulator is a type of mechanical device used for precise positioning and manipulation of objects or tools along three orthogonal axes: horizontal (X axis), vertical (Y axis), and rotational (R axis). The XYR manipulator provides multidirectional movement in a planar or three-dimensional space, allowing objects, such as containers/plates, to be positioned with high accuracy and control. In some implementations, the XYR manipulator may include an air compressor used to power pneumatic actuators or cylinders that control the movement of the manipulator along the X, Y, and R axes. In these implementations, the manipulator may include a control system, a gas supply, and one or more pneumatic actuators. The control system, which may include one or more processors, memory, various interfaces, and the like, may control the movements of the manipulator and the gas supply to each of the pneumatic actuators. The pneumatic actuators provide movement along each axis by converting the energy stored in compressed gas into mechanical motion. Each axis of the manipulator may have its own set of pneumatic actuators. The gas supply may include components that feed gas (e.g., air, nitrogen (N₂), argon (Ar), helium (Hc), hydrogen (H₂), specialty gases, and/or the like) to the pneumatic actuators. These components may include a suitable compressor that generates the necessary pressure to power the pneumatic actuators to move the manipulator in the desired directions. The compressor is controlled by the control system, which regulates the gas flow to the actuators based on commands from the manipulator's control or user interface. Additionally or alternatively, the manipulator may include other components, such as end effectors (e.g., including one or more tools), motors, sensors, controllers, and/or the like.

The first track system 103 receives containers including specimens for incubation and transports them into the incubator subassembly 101, and a second track system 104 transports containers inoculated with a sample from the incubator subassembly 101 when incubation/imaging is complete. FIGS. 1B and 1C show the imaging subsystem 102 disposed on what is designated the front of the cabinet.

The imaging subsystem 102 is configured to capture image(s) of containers/plates. The processing unit (not shown) may issue command(s) for obtaining image(s) of a container/plate. The processing unit (not shown) causes the manipulator to pick up the container from its position within the CSA 108. After removing the container from its position, the manipulator places it on shelf 122 so that the imaging subsystem 102 may obtain an image of the container/plate. After capturing the image(s) of the container/plate, the container/plate is transported by to the incubator 100 and placed back in the CSA 108. Additionally or alternatively, a series of tracks, such as track systems 103 and 104, may move containers/plates within the incubator 100, such as back and forth between the CSA 108 and the imaging subsystem 102.

The incubator 100 also includes a processing unit (not shown) that cooperates with a manipulator to inventory the sample containers as they enter the incubator. Such processing units for the inventory and monitoring of samples in a cabinet type of incubator for incubation of large number of samples in containers are well known to the skilled person and not described in detail herein. Such automated systems may include one or more processors or other dedicated logic and memory for storing and tracking information related to the sample containers in the incubator. The one or more processors of the processing unit may include one or more of central processing units (CPUs), graphics processing units (GPUs), accelerated processing units (APUs), reduced instruction set computer (RISC) processors, Acorn RISC Machine (ARM) processors, complex instruction set computer (CISC) processors, digital signal processors (DSPs), application-specific integrated circuits (ASICs), field-programmable gate arrays (FPGAs), programmable logic controllers (PLCs), baseband processors, radio-frequency integrated circuits (RFIC), microprocessors or controllers, hardware accelerators, neural processing units (NPUs), tensor processing units (TPUs), and/or any other known processing elements, or any suitable combination thereof. References to a processor should be understood to include references to a single processor or a collection of processors that may or may not operate in parallel. The processing unit tracks at least the location of the specimen in the incubator, the incubation time, the number of images to be captured, the number of times the specimen is to be imaged and duration therebetween. The processing unit may track additional information, such as the type of sample, the type of culture media, precautionary handling information (e.g., hazardous specimens), and/or the like. Additionally, one or more processors of the processing unit may include the processors or controllers of the aforementioned temperature and/or CO₂ controllers. Additionally or alternatively, the processing unit may operate suitable software applications, which may be accessed through a graphical user interface (GUI). In some implementations, the incubator 100 includes a touchscreen monitor mounted to a cabinet of the incubator 100, which is used to display the GUI. In other implementations, the GUI is displayed via a detached display device and/or separate computing device, which may access the GUI via a wired or wireless connection. In either implementation, the GUI may be used to set various incubation parameters for the incubator 100, such as the temperature and CO₂ levels, as well as monitor various aspects of the incubator 100.

Typical operation of the incubator 100 may include plate storage processes, which may include the following operations: (1) A plate is transported from the side lane of a track, such as track systems 103 and/or 104, to the infeed of a scanning mechanism, such as a reader, optical scanner, radiofrequency (RF) scanner, near field communication (NFC) scanner, and/or the like; (2) the a scanning mechanism scans a machine readable element (e.g., barcode, quick response (QR) code, RF identification (RFID) tag, NFC circuitry, and/or the like) associated with the plate to assign a storage location in CSA 108; and (3) an X-Y-R manipulator (e.g., robotic arm or the like) places the plate in the storage location. Typical operation of the incubator 100 may include plate imaging processes, which may include the following operations: (1) The manipulator retrieves a plate from its storage location in the CSA 108; (2) the plate is transported to the imaging subsystem 102 via a track system, such as track systems 103 and/or 104; (3) the machine readable element on the plate is scanned by the scanning mechanism and the plate is transported to an imaging position so that the imaging subsystem 102 may obtain an image of the plate; (4) the imaging subsystem 102 captures one or more images of the plate; and (5) the plate is transported from the imaging subsystem 102 to an outfeed section, and the machine readable element is scanned by the scanning mechanism; and the manipulator places the plate into its designated storage location. Additional components and aspects of the operation of the incubator 100 are discussed in [′871].

The incubator 100 includes features that control the composition of the atmosphere inside the incubator 100, such as the amount of CO₂ and/or oxygen (O₂) in the incubator environment. The temperature is controlled by a temperature control system, including one or more sensors and a controller (e.g., a thermostat or the like) to apply heating or cooling to the interior of the incubator 100 as needed. The level of CO₂ in the incubator 100 is controlled by a CO₂ controller connected to a valve, CO₂ cylinder, and at least one CO₂ sensor. The temperature controller and CO₂ controller may be implemented by the same or different devices.

As mentioned previously, the incubator 100 may be operated in an ambient environment at an ambient temperature between 18° C. and 27° C., and an ambient humidity of 20% to 80% RH non-condensing. The incubator subassembly 101 is the area of the incubator 100 with a controlled environment for temperature and CO₂ levels. The temperature inside the incubator may be set between 30° C. and 40° C. adjustable with increments of 0.1° C. and an accuracy of +1° C. for all plate positions. CO₂ levels may be controlled at 5%+1%. Most incubator subassemblies 101 and/or incubator cabinets implemented in currently used incubators 100 do not have active humidity control systems. Humidity is not measured by the instrument 100. In case of a too dry environment, a water pan is situated at the bottom part of the incubator 100. The water pan may be filled with water and allows for condensation to increase the RH inside the incubator 100 to prevent the agar in the plates to dry out during the incubation period.

As alluded to previously, excessive moisture may build up in the incubator 100 during operation. Excessive moisture may be experienced as drops at the so-called “thermal bridges”, which are areas where the internal and external temperature can be transferred (e.g., door seals, in/out feed pass throughs, and/or the like). Additionally, excessive moisture can be experienced as wet spots or residues on flat surfaces inside the incubator 100 because of drops that fall in or on bottom plates, in/out conveyors, and/or the like. The condensation is related to the RH and the temperature difference at the thermal bridges. At least two rules of theory may apply to the condensation in the incubator 100, including (1) warm air can hold a higher percentage of humidity, and (2) the dew point temperature, which is the temperature that saturates the water vapor that can be held in air before it condensates. As is known to persons of ordinary skill in the art, the dew point is typically closer to the actual temperature at a higher RH. For example, the set point of 35±1° C. may be marked and/or related to an RH between 60% to 90%, which is typical for the working area of the incubator 100.

Inside the incubator 100, there is a balance between the amounts of moisture added to the system and the amount of moisture escaping from the incubator space. Moisture may enter the incubator 100 through the Petri dishes filled with agar (referred to as “agar plates”) because agar has a relatively high water content. The water from the agar evaporates from the dish and fills the incubator atmosphere with moisture. Theoretically, if there are no cold spots within the incubator 100 and/or no air refreshment within the incubator, this process would continue until the air is saturated (e.g., ˜100% RH). The moisture may leave, exit, or escape the incubator 100 through the refreshment of air, since the incubator 100 is not fully airtight. As cool dry air enters the incubator 100 and absorbs the moisture present in the incubator 100, after some time, this air escapes the incubator 100 transporting the absorbed moisture out of the incubator 100. Upon leaving the incubator 100, the moisture can condense whenever it makes contact with cooler surfaces. The refreshment of air is, however, limited and varies from incubator to incubator. The humidity measured inside the incubator will be the humidity level reached at the balance point between the evaporation of the agar and moisture removal due to air refreshment inside the incubator. Thus, the air refresh rate is an important factor to monitor, measure, and control.

Typically, the RH inside the incubator 100 is maintained between 60% to 80% to prevent dried agar and excessive condensation. To maintain a RH between 60-80%, the refresh rate of a full incubator (e.g., about 1000 plates) should be between 400-500 liters per hour (1/hr). However, with fewer plates in the incubator 100, the humidity could drop below 60%. In cases with fewer than the maximum number of plates, the water pan can be used to allow additional water to evaporate and raise the RH inside the incubator 100. In other words, the RH inside the incubator 100 is a result of the number of plates inside the incubator 100 and the air tightness of the incubator 100. The more plates inside the incubator 100, the more moisture that evaporates from the agar, and thus, the higher the RH inside the incubator 100.

In general, the cause of the excessive condensation is the temperature difference at the thermal bridges and the RH inside the incubator 100. These two factors determine the dew point, which is the temperature that can hold the water vapor in air before it condensates. The amount of water vapor that can be held in air decreases when the temperature drops. As the incubator set point temperature and lab ambient temperature are similar to the set point/ambient temperatures for incubators that do not experience the condensation issue, the RH inside the incubator 100 is most likely the factor causing the condensation that results in excessive moisture.

To achieve a RH between 60%-80% inside the incubator 100 to prevent excessive condensation, a leak (or air gap) configured to allow an airflow between 400-600 l/hr may be created. Depending on the used incubator capacity, this can be achieved by installing an airflow kit, which are two parts that create an opening between the door and seal at the top and bottom position of the incubator door. However, leaving an opening in the door/seal is not a desirable solution because of potential control and contamination issues.

According to various embodiments, a humidity control upgrade kit, such as humidity control subassembly 200, may be retrofitted or otherwise installed in a variety of heated cabinets, such as incubator 100. As mentioned previously, the temperature and CO₂ concentration inside the incubator 100 is controlled by a temperature and/or CO₂ control system(s). The rise in temperature inside the incubator 100 causes water in/on the agar plates to evaporate, increasing the humidity inside the incubator 100. The humidity control upgrade kit includes a humidity control system that is able to reduce the RH levels inside the incubator 100 by, for example, blowing dry and filtered air into the incubator when the RH reaches one or more thresholds or setpoints. The humidity control upgrade kit minimizes a condensation in the incubator by reducing the humidity levels through ventilating with compressed air, while maintaining sample integrity. The humidity control upgrade kit is designed to be compatible with most existing incubator types, which allows the kit to be used in existing incubators without the need for incubator redesigns or expensive teardowns. Furthermore, the usage of dry compressed air (obtained by an external compressor) to dry the environment in the incubator 100, reduces the number of components used inside the incubator 100 itself.

For example, humidity testing has shown that, without humidity control within incubator cabinets, the humidity, depending on dewpoint, may rise to 76% RH at 40° C. (a dewpoint of 35° C.) or 84% RH at 30° C. (a dewpoint of 27° C.). During these situations, moisture buildup at cold spots 115 was noticed. The moisture buildup occurred at the cold spots 115 of the reinforcement beam 106 inside the incubator cabinet wall, as shown by FIG. 1F. This moisture buildup extracts extra water from the air inside the incubator 100 and limits the maximum RH that can be achieved. Also, moisture build up at the openings of the imaging subsystem 102 was noticed where the outer wall is close to the inner temperature of the incubator 100. This moisture buildup could potentially affect the quality of the plate transport mechanisms to/from the imaging subsystem 102 and/or the quality of the images captured by the imaging subsystem 102. After turning on the humidity control, such as by using the humidity control subassembly 200, the RH is controlled to a setpoint of at least 60% by blowing in dry shop air. During these reduced RH setpoint tests, moisture build up will not be observed/was not observed at the cold spots 115.

The humidity control system blows in extra shop air increasing air refreshment, but also pushes CO₂ out of the incubator environment. Environments requiring a certain amount of CO₂ may require additional CO₂ to be pumped into the incubator 100 in order for the CO₂ levels stay at a desired setpoint. Therefore, the CO₂ consumption depends on the total air leakage, and an increase in CO₂ consumption may be observed when using the humidity control mechanism described herein. During testing, to reduce the RH to a 60% RH target, the humidity control mechanism may constantly blow air into the incubator 100 at approximately (˜) 18 l/min, which corresponds with ˜1080 l/hr (18×60) refreshment rate with the control mechanism active. These refresh rates are at the limit of ˜50 l/h CO₂ consumption. To prevent condensation buildup while reducing the overall CO₂ consumption, a 72% RH setpoint is determined to be sufficient for most incubators 100. This setpoint may keep the dewpoint below the temperature of the cold spots 115. During testing (e.g., 40° C. at 72% RH), a 511 l/h refreshment rate was measured corresponding to 25 l/h CO₂ consumption.

The humidity control system is able to reduce the RH control inside the incubator to a minimum of 60% without effecting the temperature homogeneity, but it comes with a cost of extra CO₂ consumption and shop airflow. Depending on the humidity (or RH) setpoint, this could come close to/over the limits of the maximum CO₂ consumption. Tests have demonstrated that a setpoint of about 72% RH should be enough to prevent condensation at incubator operating temperatures, with a resulting CO₂ consumption of 25 l/h which is below most incubation specifications.

To increase the RH setpoint and to lower the CO₂ usage, cold spots, such as cold spots 115, should be avoided. Reducing the cold spots inside the incubator 100 may increase the setpoint of the humidity control, and therefore, lower the air and CO₂ consumption. Because it is possible to reduce the humidity setpoint below 60%, which may degrade sample integrity, the humidity control mechanisms discussed herein also include mechanisms for determining an appropriate RH setpoint.

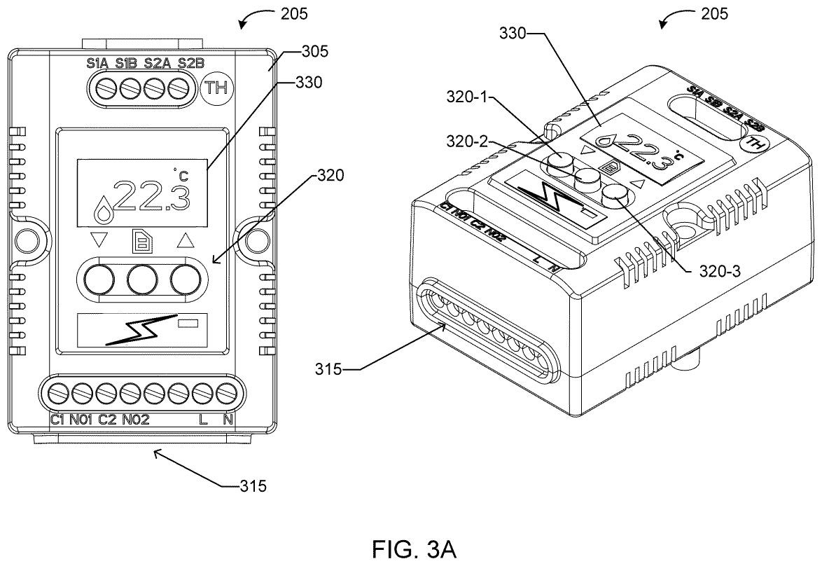

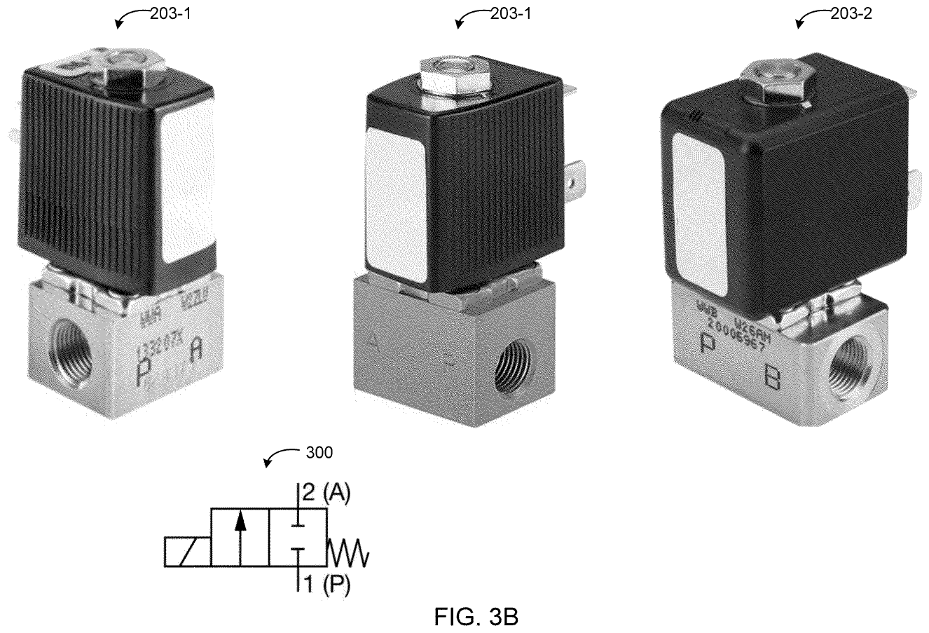

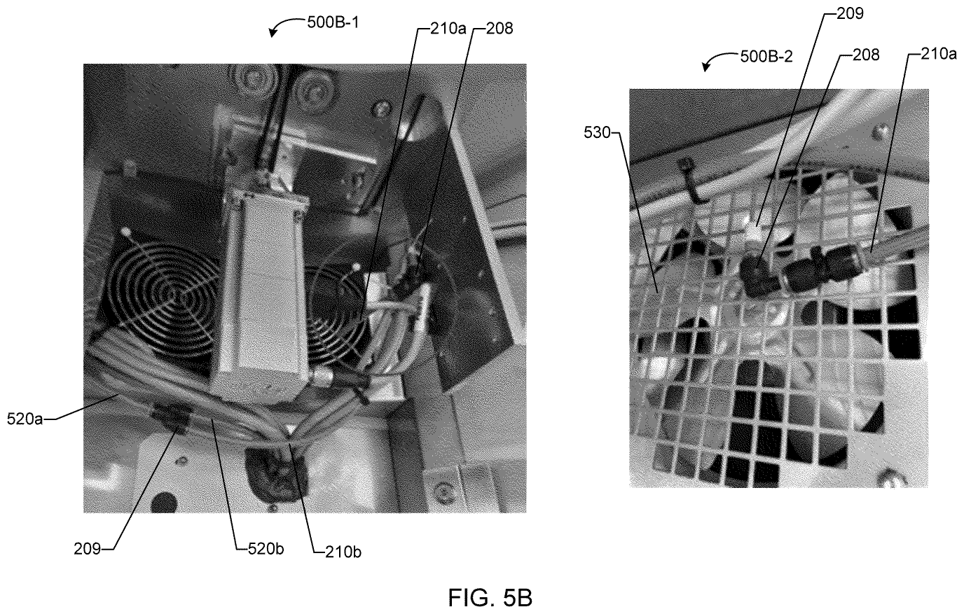

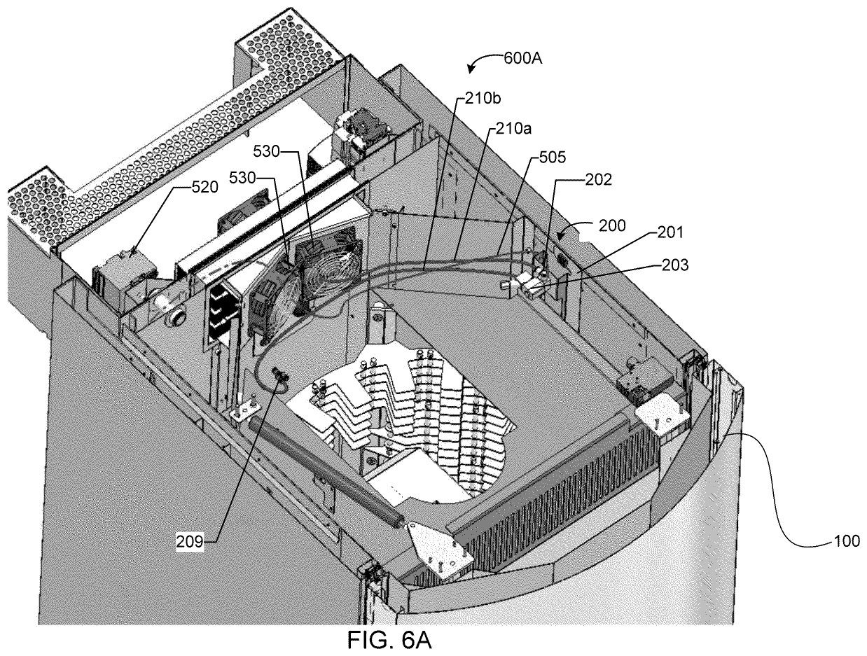

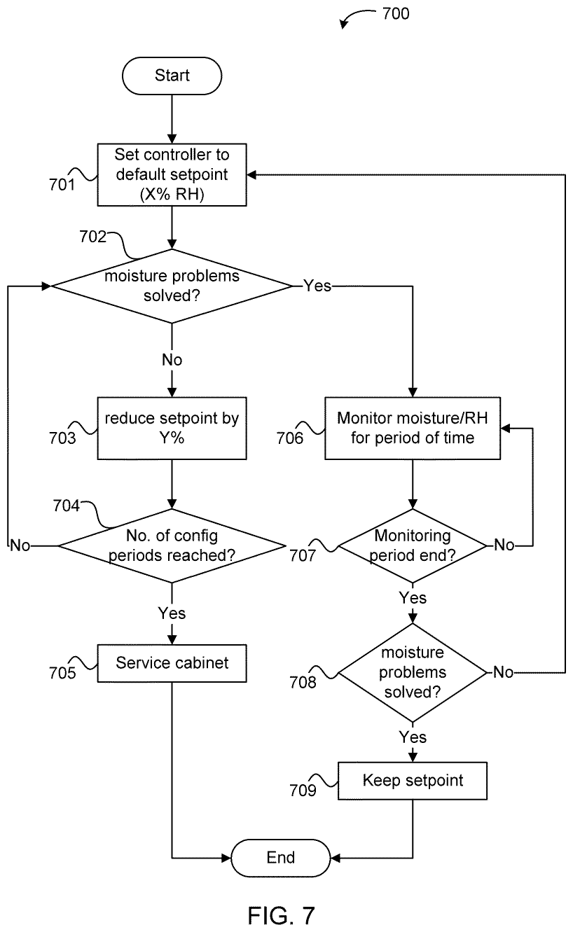

The humidity control mechanisms discussed herein, such as the humidity control subassembly 200 of FIGS. 2A and 2B, is capable of reducing the RH levels inside the incubator 100 by blowing dry and filtered compressed air into the incubator environment when the RH level increases beyond a desired amount, exceeds a threshold, and/or moves beyond one or more setpoints. The system includes a self-contained humidity controller, such as a humidity controller 205 in FIGS. 2A and 2B, which measures the RH inside an incubator 100 and compares the RH to a configurable setpoint. When the setpoint is reached, the humidity controller 205 controls a relay to switch a pneumatic valve 203. The pneumatic valve 203 controls or governs the flow of air inside the incubator 100. The pneumatic valve 203 allows compressed air to blow in front of a heating element to avoid disturbance in the temperature distribution of the incubator 100. Because the air inside the incubator 100 is constantly circulated by fans, such as fans 530 shown by FIGS. 5A and 7H, fresh and moist air may mix relatively evenly. The humidity controller 205 causes air to blow inside the incubator 100 until a configurable hysteresis setpoint is reached. When the hysteresis setpoint is reached, the humidity controller 205 switches off the pneumatic valve 203. This regulating behavior causes the humidity level inside the incubator 100 to stabilize around the configured setpoint. In some implementations, a default setpoint of 72% RH may be configured as a factory default, and individual users may configure their own desired RH setpoints.

A hysteresis setpoint is a control mechanism or technique used in various control systems, which involves setting two different threshold values, one for activating a process or action and another for deactivating it, with a gap or difference between the thresholds. A hysteresis setpoint introduces a buffer or margin between the point where a system starts a certain action (activation threshold) and where it stops that action (deactivation threshold). This gap helps prevent rapid or unnecessary switching of the system due to minor fluctuations or noise in the input signal, and/or filters signals so that the output reacts less rapidly than it otherwise would by taking recent system history into account.

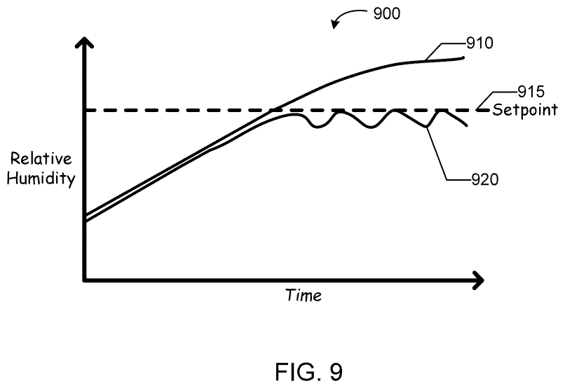

FIG. 9 is a graph 900 demonstrating the regulating behavior of the hysteresis setpoint. The x-axis of the graph 900 represents time and the y-axis of the graph 900 represents RH. Curve 910 shows the RH inside the incubator 100 during operation of the incubator 100 when the humidity control mechanism is inactive. Curve 910 shows that the RH inside the incubator 100 steadily increases and then levels off as it gets closer to a maximum RH, which is above the desired incubator RH. Curve 920 shows the RH inside the incubator 100 during operation of the incubator 100 when the humidity control mechanism is active. Here, the RH inside the incubator 100 steadily rises until it reaches a setpoint 915, and which point the humidity control mechanism causes air to be pumped into the incubator 100 until the RH drops to a desired amount. When the RH drops to the desired amount, the humidity control mechanism deactivates or otherwise stops pumping air into the incubator 100. This process repeats for as long as the incubator 100 is operating, or until an operator disables the humidity control mechanism

In various embodiments, a hysteresis setpoint, such as setpoint 915 in FIG. 9, may involve setting two humidity levels, a first humidity level for activating the dehumidifying mechanisms and a second humidity level for deactivating the dehumidifying mechanisms, with a predetermined gap between these humidity levels to prevent rapid cycling of the system. For example, the humidity controller 205 controlling the desired humidity level in an incubator 100 may be set to 72% RH, and the hysteresis may be set to 5% RH. This means the humidity controller 205 turns on when the RH increases to 77% RH and remains on until the RH drops to 67% RH before turning off. The hysteresis setpoint prevents the pneumatic valve 203 from constantly being turned on and off due to minor fluctuations in RH, providing more stable and efficient humidity control in the incubator 100.

Typically, consumer-grade compressors provide compressed air in accordance with ISO 8573-1:2010 [4:4:4], which specifies particle class 4 (allowing up to 10000 particles with a size of 1 to 5 microns (μm)), water class 4 (allowing a maximum pressure dew point (PDP) of ≤+3° C.), and oil class 4 (allowing a maximum oil content of ≤5 mg/m³). In various implementations, the compressed air in incubator 100 is filtered in accordance with ISO 8573-1:2010 [1:7:2], which specifies compressed air with particle class 1 (allowing 20,000 or fewer particles with a size of 0.1 to 0.5 μm, 400 or fewer particles with a size of 0.5 to 1 μm, and 10 or fewer particles with a size of 1 to 5 μm), water class 7 (allowing a maximum liquid content of ≤0.5 g/m³), and oil class 2 (allowing a maximum oil content of 0.1 mg/m³). This means that the overall air reaching the incubator 100 at the humidity control system has a dewpoint of maximal +3° C. The usage of dry compressed air (obtained by an external compressor) to dry the environment in the incubator 100 allows for the reduction of the number of components, such as the number of components of the humidity control subassembly 200, used inside the incubator 100 itself.

### 2. Humidity Control Subassembly Embodiments

### 2.1. Example Components

FIG. 2A shows a view of an example humidity control subassembly 200 that may be implemented in a heated cabinet, such as incubator 100. FIG. 2B shows an exploded view of the humidity control subassembly 200. The humidity control subassembly 200 includes a bracket 201, flow control device 202 (also referred to herein as “valve 202” and/or the like), valve and connector 203 (also referred to herein as “pneumatic valve 203”, “valve 203”, and/or the like), L-connector 204 (also referred to herein as “air coupling 204”, “fitting 204”, and/or the like), controller 205 (also referred to herein as “hygrostat 205”, “humidistat 205”, “hygrotherm 205”, and/or the like), guide cap 206, silencer 207 (also referred to herein as “pneumatic muffler 207” and/or the like), fitting 208 (also referred to herein as “coupling 208”, “connector 208”, and/or the like), fitting 209 (also referred to herein as “coupling 209”, “connector 209”, and/or the like), and tubing 210a and 210b (also referred to herein as “tubes 210”, “hoses 210”, “pneumatic connections 210”, and/or the like).

The bracket 201 is a structural component that is used to support or connect the other components of subassembly 200. The other components of subassembly 200 may be mounted on the bracket 201. The bracket 201 may also be mounted on the inner walls of a heated cabinet, such as incubator 100. In the example of FIGS. 2A and 2B, the bracket 201 may be mounted to an inner wall of the incubator cabinet by securing it with screws through holes 311a, 311b in the bracket 201. Other fasteners or connection means, such as magnets, adhesives, and/or the like, may be used in other implementations. The bracket 201 may be made from various materials including steel, stainless steel, aluminum, plastics, and/or other suitable materials, or combinations thereof. The depicted design of the bracket 201 may be based on the specific design of the incubator 100, however, the design of the bracket 201 may be altered based on the specific dimensions and/or parameters of the specific heated cabinet in which it is deployed. The design of the bracket 201 may also be governed by engineering principles to ensure adequate strength and stability of the other components.

The flow control device 202 regulates the flow rate of a fluid or gas, such as compressed air, by controlling the speed or volume of the fluid or gas passing through it. Here, the flow control device 202 may limit the airflow into the heated cabinet, such as incubator 100. The flow control device 202 may be a flow control fitting or a flow control valve. Flow control fittings typically include components such as adjustable orifice plates, flow restrictors, and/or inline flow regulators that can manage flow rates. Flow control valves tend to be more sophisticated devices that actively adjust the flow of fluid or gas based on external inputs such as pressure, temperature, and/or electronic signals. In either case, the flow control device 202 may respond to sensors and/or control systems, such as those of the humidity controller 205. In an example implementation, the flow control device 202 may be flow control valve, such as SMC AS2201F-01-06-6-X250 provided by SMC Corp. This valve 202 has a R⅛ threaded fitting and is compatible with tubing having an outside diameter (Ø) of 6 mm (e.g., Ø 6 mm tubing). Additionally, this valve 202 may limit the airflow down to 18 l/min.

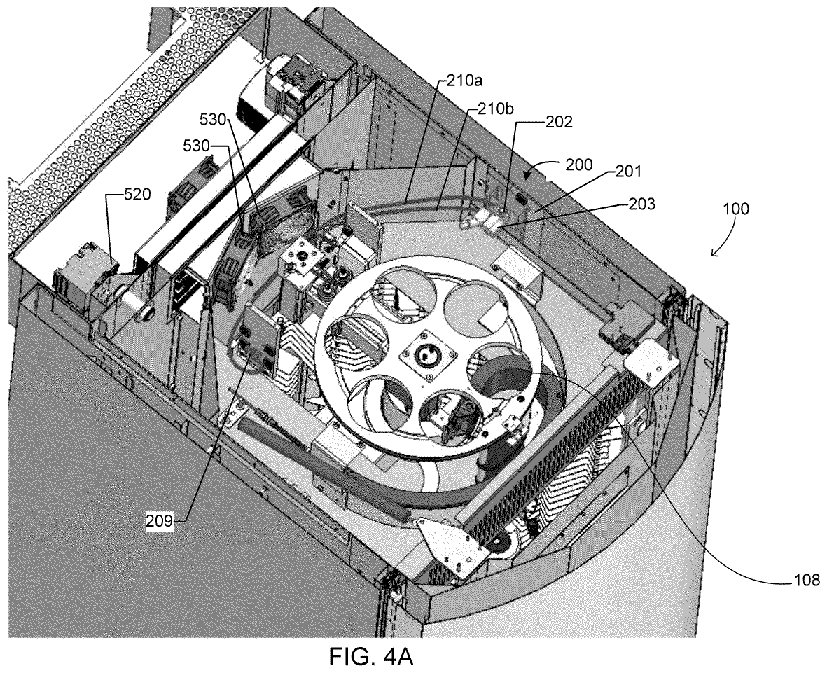

As shown by FIG. 2A, a first end of tubing 210a may be configured to connect to the flow control device 202 via a first connector of the flow control device 202. The first connector of the flow control device 202 is shown as extending from a side of the flow control device 202. The first connector may be a port or female connector configured to receive a male connector of the tubing 210a. As shown by FIGS. 2B and 3C, a second connector on the bottom of the flow control device 202 may be configured to fit into a corresponding connector on a top section of the pneumatic valve 203. The second connector of the flow control device 202 may be a threaded male connector and the top section connector of the valve 203 may be a threaded female connector. A second end of the tubing 210a may be connected to a second end of the fitting 208, wherein a first end of the fitting 208 is connected to the silencer 207.

The silencer 207 is a device used to reduce the noise generated by the rapid release of compressed air or gas in a pneumatic system, such as the subassembly 200. The silencer 207 may be installed at an exhaust port to attenuate the noise level created when gas, such as compressed air, CO₂, and/or the like, is exhausted from a pneumatic components, such as the flow control device 202, valve 203, and/or an air/CO₂ compressor. The silencer 207 may include a series of baffles, walls, or chambers inside the silencer 207, which allow the air to expand gradually, which dissipates the energy of the airflow and reduces the intensity of the sound. In some example implementations, the silencer 207 may be implemented as a push-in silencer UC-QS-4H provided by Festo®, which may be G⅛ threaded for a pneumatic connection. In some example implementations, the fitting 208 may be implemented as a push-in L-connector QSML-6 provided by Festo®, which includes two female pneumatic connection ports (e.g., an inlet port and an outlet port) configured for Ø 6 mm tubing.

Referring back to FIG. 2A, the valve 203 may also include another connector on a bottom section of the valve 203 (not shown by FIG. 2A or 2B), which may be configured to couple with a first connector of the L-connector 204. The valve 203 may be mounted to the bracket 201 by securing it with screws 309 through holes 312 in the bracket 201, as shown by FIG. 2B. Note that not all holes 312 are labeled in FIG. 2B. Other fasteners and/or connection means, such as magnets, adhesives, and/or the like, can be used in other implementations. In an example implementation, the screws 309 may be embodied as cylindrical head cap screws 309 screws with a hex socket drive and a hexagonal recess, have a thread diameter of M3 and a length of 4 mm (M4×45) (e.g., DIN 912-M3×4), and be made of stainless steel (e.g., A2-70 stainless steel). Other materials and dimensions may be used for the screws 309 in other implementations.

FIG. 3B shows various views of example pneumatic valves 203, including valves 203-1 and 203-2. The pneumatic valve 203 may be any valve used to control the flow of compressed air and/or CO₂ into the incubator 100. In an example implementation, the valve 203-1 is a Bürkert type 6011 (article no. 134071) valve. This valve 203-1 is a 2/2-way-solenoid valve, direct-acting, normally closed valve, which is operated with 24 volts (V) and direct current (DC). The valve 203-1 includes port A and port P, both of which may be G⅛ threaded. In another example implementation, the valve 203-2 is a Bürkert type 7011 (article no. 20001263) valve. This valve 203-2 is a 2/2-way-solenoid valve, direct-acting, normally closed valve, which is operated with 24V and DC. The valve 203-2 includes port B and port P, both of which may be G⅛ threaded. In either implementation, the valve 203 operates according to circuit function 300, which indicates that the valve 203 is a direct-acting, normally closed, 2/2-way solenoid valve. Since the valve 203 is a normally closed valve, the humidity control may stop as soon as the system is shut down and/or when system is no longer powered.

As mentioned previously, the valve 203 may be configured to couple with a first connector of the L-connector 204. In an example implementation, the L-connector 204 may include a threaded male pneumatic connector configured to be fastened to threaded female connector of the valve 203. The male pneumatic connector may also be a pneumatic connection port that allows gas to flow through it. Additionally, the L-connector 204 may include a female pneumatic connection port configured to couple with tubing 210b. In this example, the L-connector 204 may be implemented as a push-in L-fitting QSL-1/8-6 provided by Festo®, wherein the male connector includes R⅛ threads and the female port is configured for Ø 6 mm tubing.

As shown by FIG. 2A, a first end of tubing 210b may be configured to connect to the female port of the L-connector 204. A second end of the tubing 210b may be connected to fitting 209. The fitting 209 may connect to a gas supply element, such as a gas compressor(s) (e.g., reciprocating, rotary screw, rotary vane, centrifugal, scroll, diaphragm, and/or other types of compressors), gas tank(s) or cylinder(s) (e.g., high-pressure, compressed gas, liquefied gas, and/or other types of tanks/cylinders), and/or the like. In an example implementation, the fitting 209 may be implemented as a push-in Y-connector QSMY-6 provided by Festo®, which includes three female pneumatic connection ports (e.g., two inlet ports and one outlet port, or vice versa), each of which is configured for Ø 6 mm tubing.

The guide cap 206 is an optional component, which may be included with the humidity control subassembly 200 depending on the type of heated cabinet that the humidity control subassembly 200 is installed in. For example, in some implementations, a guide cap (not shown) may be used to assist with guiding a hood or cover on or in the incubator. In these implementations, the guide cap 206 may replace the existing guide cap (not shown) that is already installed in such incubators 100. Here, the guide cap 206 is reduced in thickness by the plate thickness of the bracket 201 in order for the hood to be able to fit during normal operation of the incubator 100. The guide cap 206 may be mounted on the bracket 201 using the through hole 311b and a suitable fastener or other connection mechanism. In some implementations, the guide cap 206 may be formed to have threads and may be screwed on to the bracket 201. The through hole 311b may also be used to mount the subassembly 200 on an inner wall of the incubator 100 using such fastener or other connection mechanism. For example, suitable fasteners may be inserted through holes 311a, 311b and existing holes on the inner wall of the incubator 100, and thus, such existing holes on the inner wall of the incubator 100 may be reused to mount the bracket 201 inside the incubator 100.

The controller 205 is an electronic device used to measure and control humidity levels in an environment. The controller 205 may be mounted to the bracket 201 by securing it with screws 307 and nuts 308 through holes 313 in the bracket 201, as shown by FIG. 2B. Note that not all holes 313 are labeled in FIG. 2B. Other fasteners and/or connection means, such as magnets, adhesives, and/or the like, can be used in other implementations. In an example implementation, the screws 307 may be embodied as cylindrical head cap screws 307 screws with a hex socket drive and a hexagonal recess, have a thread diameter of M4 and a length of 45 mm (M4×45) (e.g., DIN 912-M4×45), and made of stainless steel (e.g., A2-70 stainless steel). Additionally, the nuts 308 may be embodied as hex nuts 308 having a thread diameter of M4 and a length of 45 mm (M4×45) (e.g., DIN 934 M4), and made of stainless steel (e.g., A2-70 stainless steel). Other materials and dimensions may be used for the screws 307 and/or nuts 308 in other implementations.

FIG. 3A shows front and perspective views of an example humidity controller 205. In this example, the humidity controller 205 is a hygrostat. A hygrostat is an electronic device that is analogous to a thermostat, but responds to relative humidity instead of temperature. The humidity controller 205 may include at least one humidity sensor (not shown by FIG. 3A) that detects the humidity (or RH) level inside the heated cabinet. The humidity sensors may be capacitive humidity sensor(s), resistive humidity sensor(s), thermal humidity sensor(s), gravimetric humidity sensor(s), optical humidity sensor(s), piezoelectric humidity sensor(s), and/or other types of humidity sensor(s) and/or any combination thereof. Additionally or alternatively, other types of sensors, such as thermal conductivity sensors and/or other types of moisture detecting sensors such as those mentioned herein, can be used by the humidity controller 205. In these implementations, the humidity controller 205 may be configured to convert the sensor data from such sensors into an RH value. In the depicted examples, the at least one humidity sensor (or other type(s) of sensor(s)) may be enclosed in a housing 305 of the humidity controller 205. However, in other implementations, one or more humidity sensors (or other type(s) of sensor(s)) may be external to the humidity controller 205 and placed in various locations within the incubator cabinet. In such implementations, the one or more external humidity sensors (or other type(s) of sensor(s)) may be connected to a controller or processor of the humidity controller 205 via wired or wireless connections/links. In these implementations, the humidity controller 205 may include suitable wired and/or wireless communication interface to connect with the sensor(s).

The humidity controller 205 may also include a controller or processor(s) (not shown by FIG. 3A). The controller/processor(s) process signal(s) received from the humidity sensor(s) (e.g., sensor data/signaling), and determines whether an action needs to be taken to adjust the humidity level, such as switching the pneumatic valve 203 on or off. This determination may be based on one or more setpoints configured in, and stored by, memory circuitry of the humidity controller 205. The controller/processor(s) may be any suitable type of microcontroller and/or other types of processor(s), such as any of those mentioned herein.

The humidity controller 205 includes user interface elements, such as input device(s) 320 and output device(s) 330, which may be connected to the controller/processor(s) via suitable input and output interfaces. The input device(s) 320 are provided for setting the desired humidity (RH) levels/setpoints. The output device(s) 330 are provided to show a current humidity level, the setpoint(s) (e.g., during a setup or configuration process), and possibly other relevant information.

In the example of FIG. 3A, the output device(s) 330 comprises a display device and the input device(s) 320 includes a series of physical buttons, including buttons 320-1, 320-2, and 320-3. Here, buttons 320-1 and 320-3 are configured as down and up arrows, respectively, allowing a user to cycle through menu options, cycle through operational modes, decrease/increase temperature and/or humidity setpoint values, and/or other aspects displayed on the display 330. Additionally, button 320-2 may be used to select or confirm selected options, view recorded and stored data and/or statistics, and/or other perform functions. Other functions may be programmed into the device 205 for each button 320.

Although the example of FIG. 3A includes physical buttons, the input device(s) 320 can additionally or alternatively include other input devices such as switches, dials, knobs, a keypad, a touchpad, a touchscreen, microphones, cameras (including visible light, thermal, infrared, and/or other types of imaging devices), and/or other input devices. The output device(s) 330 can additionally or alternatively include other output devices, such as audio devices (e.g., speakers or other audio emitting devices), other visual output devices such as individual light emitting diodes (LEDs), projectors, actuators and/or haptic feedback devices, and/or the like. In some implementations, the input and output device(s) 320, 330 may be combined as a touchscreen device, where the physical buttons 320 may be replaced by graphical elements that may be displayed to a user. In these implementations, the input devices 320 may be virtual components (e.g., software components) accessible via the touchscreen. Additionally or alternatively, the input and output device(s) 320, 330 may be provided by an external computing system in wireless communication with the humidity controller 205. Such an external computing system may be, for example, a server, a desktop computer, laptop computer, smartphone, tablet computer, wearable computing device, and/or the like. In these implementations, the humidity controller 205 may also include suitable wired and/or wireless communication interface to connect with the external computing system.

The humidity controller 205 also includes interface 315 for electrically coupling the humidity controller 205 with external devices, such as the pneumatic valve 203, a power source 520, and/or other external devices. In this example, the interface 315 includes a set of physical ports (also referred to as “terminals”, “sockets”, “slots”, and/or the like) configured to receive plugs, ferrules, and/or other connectors. In some examples, the controller/processor(s) of the humidity controller 205 are connected to one or more actuators, such as actuator(s) in the pneumatic valve 203 that control the flow of gases into the incubator 100, through the electrical connections of the interface 315.

Additionally or alternatively, the humidity controller 205 may include one or more actuators. Depending on the design of the hygrostat, an actuator may be included to regulate the humidity (RH) levels. The actuator(s) could include an on/off switch for controlling a pneumatic device, such as valve 203, gas (e.g., air and/or the like) compressor(s), and/or the like, and/or the actuator(s) could be more complex, such as a motorized damper for controlling airflow. Additional or alternative examples of any of the aforementioned actuator(s) can include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, and/or any other electromechanical components/devices.

In some implementations, the humidity controller 205 is embodied as an electronic hygrotherm may, which may include the aforementioned components in addition to temperature sensor(s) to sense the RH and ambient temperature (AT) of an enclosure or cabinet, such as incubator 100. In these implementations, the controller/processor(s) of the hygrotherm monitors the RH and AT, and controls various electrical/electronic components to adjust and/or maintain desired RH and AT. In the example of FIG. 3A, the humidity controller 205 may be embodied as the Climasys CC™ electronic hygrotherm (NSYCCOHYT30VID) provided by Schneider Electric®. This device operates on 24V DC. This device measures the RH in a range of 20% to 80%, and measures AT in a range of −40° C. and +80° C. An optional external negative temperature coefficient (NTC) sensor/thermistor can be used. The output device 330 comprises an organic light-emitting diode (OLED) display screen, which may display RH, temperature (in ° C. and Fahrenheit (° F.)), among other information/data. This hygrotherm allows for the setting of an RH setpoint, including a 3% hysteresis. When the setpoint is reached an internal relay is switched to control one or more pneumatic components, such as any of those mentioned herein. Using this hygrotherm, the valve 203 may be connected to relay 2 (R2), which is/are connected to the C2 and NO2 ports 315 (FIG. 5B). The R2 is in (HF) mode, which is controlled by the minimum temperature and maximum humidity. In HF mode, the relay R2 engages when the temperature is low or the humidity is high, depending on the reading by the controller's 205 internal probes. During usage, the hygrotherm may be placed in an “N3” mode. The N3 mode (“differencel”) may cool/heat with the exterior temperature and/or humidity and provides humidity and temperature control.

In alternative implementations, a special-purpose humidity controller 205 can be built and programmed, which is specifically tailored to handle RH levels in heated cabinets, such as incubator 100. In other implementations, the control element of the system may be embedded within the already existing PLC architecture of the incubator 100. In these implementations, the control logic of the humidity controller 205 as discussed herein may be implemented in the existing PLC of the incubator 100 rather than using a separate device/controller 205.

### 2.2. Humidity Control System Placement

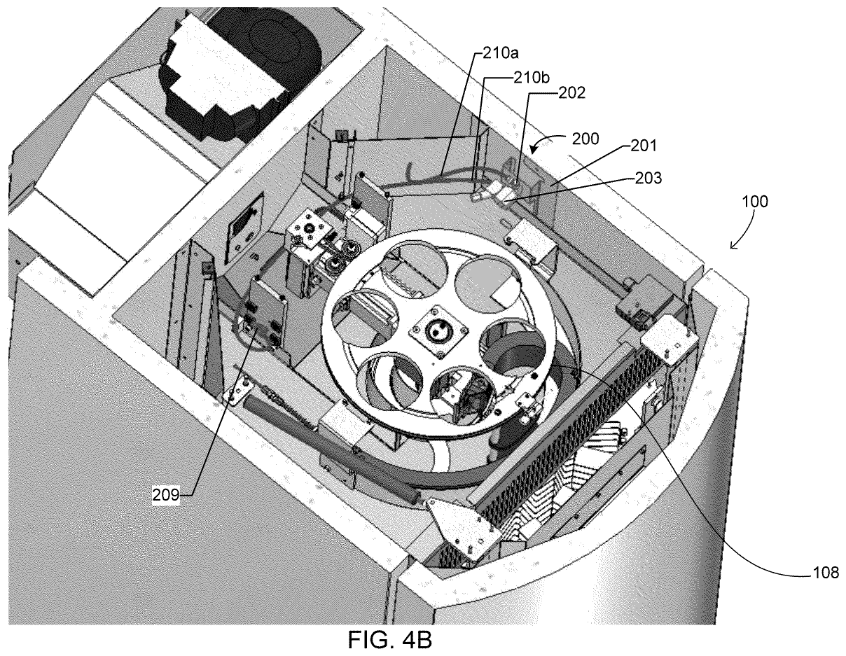

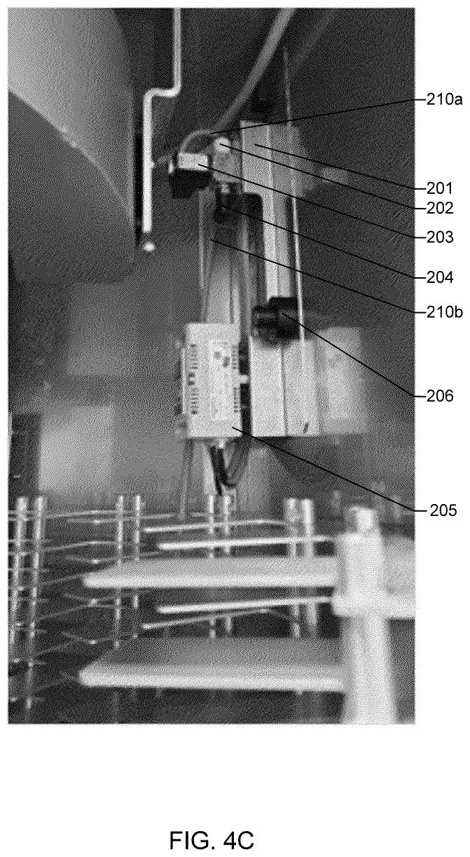

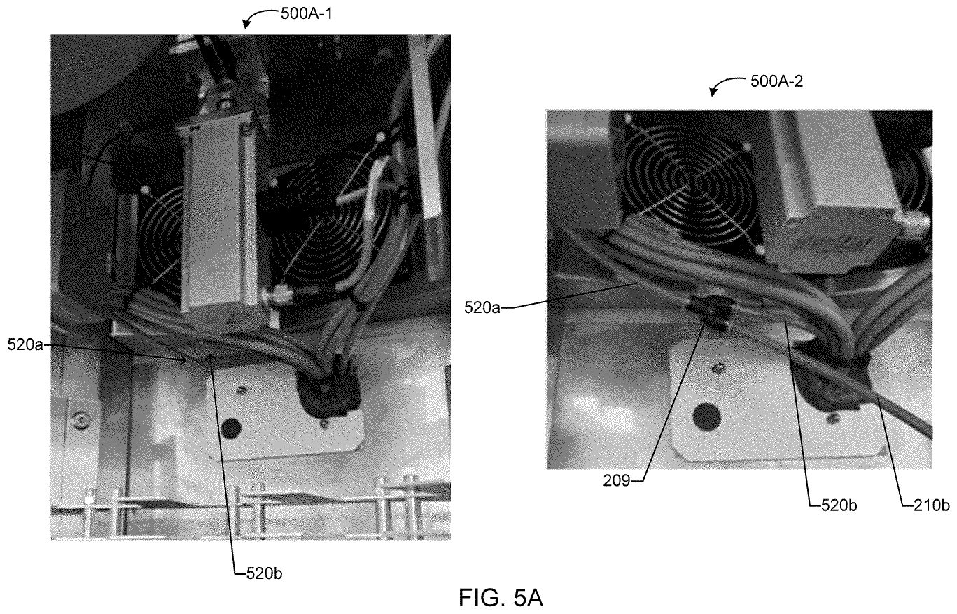

FIGS. 4A and 4B show the placement of the humidity control system in different types of incubators 100. In the examples of FIGS. 4A and 4B, the humidity control subassembly 200 may be installed in a top section of the incubator 100 on existing mounting holes. The humidity controller 205 is mounted such that it is reachable without having to disassemble anything to allow access for configurating the controller 205 after installation. FIG. 4C shows a side view of the humidity control system installed in an incubator 100.

One difference between the depicted incubators 100 is the heating element and its position within the incubator 100. For example, FIG. 4A shows a first type of incubator 100, which includes a thermoelectric module (also known as a Peltier device, Peltier cooler, Peltier heat pump, solid state thermoelectric cooler (TEC), solid state refrigerator, and/or the like). The thermoelectric module is a type of solid-state heat pump that transfers heat from one side of the device to the other side of the device when an electric current (e.g., DC electric current) is applied to the device so that one side gets cooler while the other gets hotter. The first type of incubator 100 also includes fans 530 positioned behind vents (see e.g., FIGS. 5A and 5B), which blow air directly on to the heating element.

FIG. 4B shows a second type of incubator 100, which includes a compressor-type heating element. For example, the compressor-type heating element may include an evaporator coil that contains refrigerant or some other compound that absorbs heat from outside air causing it to evaporate into a gas. The compressor compresses the gaseous refrigerant, which increases its temperature. The high-pressure, high temperature refrigerant gas then moves to a condenser coil where it releases its heat to the incubator environment inside the incubator 100. After releasing the heat inside the incubator 100, the now-cooler refrigerant passes through an expansion valve (or access valve) lowering its pressure and temperature before returning to the evaporator coil to start the process again. The second type of incubator 100 also includes fans 530 and vents (not shown by FIG. 4B) that direct airflow or other gas onto the conventional (compressor) heating element. However, the fans 530, vents, and heating element(s) of the second type of incubator 100 conventional incubator are located inside shafts.

Since gas (e.g., compressed air, CO₂, and/or the like) is blown in front of the heating element, the routing of the pneumatic hoses 210 is different for each type of incubator 100. For example, as shown by FIG. 4A and image 500B-1 in FIG. 5B, the fitting 208 and silencer 207 connected to tubing 210a is/are positioned as close as possible to Peltier ventilator (not labeled in FIG. 4A or 5B). In another example, as shown by FIG. 4B and image 500B-2 in FIG. 5B, the fitting 208 and silencer 207 connected to tubing 210a is/are positioned as close as possible to the venting holes of the conventional heating element (not labeled in FIG. 4B or 5B).

### 2.3. Electrical Connections

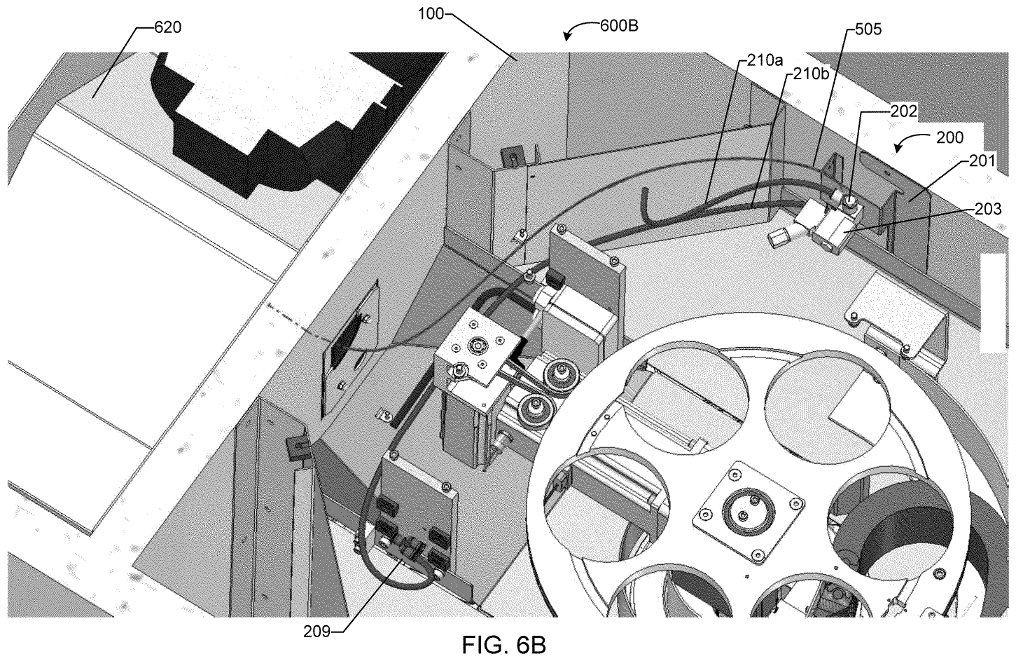

Besides the pneumatic routing, the electrical connections is different for each type of incubator 100. In some implementations, a 24V DC electric current source may be used to power the humidity controller 205 and the pneumatic valve 203. This power source is available on different locations per incubator type. These differences are discussed infra with respect to FIGS. 6A and 6B.

FIG. 6A shows an example cable routing 600A for the first type of incubator 100, such as the incubator shown by FIG. 4A. Here, a cable 505, including one or more electrical wires, is routed from the humidity controller 205 and/or valve 203 through a cable hole underneath the Peltier to a PLC terminal strip 520. The PLC terminal strip 520 may act as a power source for the controller 205 and/or valve 203.

FIG. 6B shows an example cable routing 600B for a second type of incubator 100, such as the incubator 100 depicted by FIG. 4B. The second type of incubator 100 uses a similar routing as the first type of incubator 100 discussed previously with respect to FIG. 6A. One difference between the routing 600A and 600B is the connection to the 24V power supply 620 as shown by FIG. 6B.

### 2.4. Pneumatic Connections

In some implementations, the gas input to the valve 203 is tapped from a gas line that supplies gas (e.g., air, N₂, Ar, He, H₂, specialty gases, and/or the like) to the pneumatic actuators of the XYR manipulator. In these implementations, a Y-coupling, such as fitting 209, is added in this line that routes to the valve 203. For example, as shown by image 500A-1 in FIG. 5A, a pressure hose 520 may be cut to produce hose ends 520a and 520b. As shown by image 500A-2 in FIG. 5A, hose ends 520a and 520b may be inserted into respective connectors/ports of Y-connector 209, and the air supply hose 210b may be connected to another connector/port of Y-connector 209. The other end of the air supply hose 210b is connected to L-connector 204 on a bottom side of the valve 203 (not shown by FIG. 5A; see e.g., FIG. 2A). In other implementations, a separate gas supply (e.g., gas tanks, compressors, and/or the like) can be used to supply gas (e.g., air, O₂, CO₂, specialty gases, and/or the like) to the pneumatic valve 203. In these implementations, fitting 209 may be formed of any suitable shape to route the gas to the valve 203.

In any of the aforementioned implementations, at the blow-off section, an L-coupling, such as coupling 208, may be added to aim the air in front of the heating element. Additionally or alternatively, a push-in silencer, such as silencer 207, is placed at the end of the blow-off, such as fans 530 or the like, to reduce the sound level of the system. For example, as shown by image 500B-1 in FIG. 5B, the air supply tube 210a is positioned in front of a right-side Peltier ventilator when the humidity control system is installed in the first type of incubator 100. In another example, as shown by image 500B-2 in FIG. 5B, the air supply tube 210a may be positioned in front of the ventilator in the air duct when the humidity control system is installed in the second type of incubator 100 with a conventional heating element. Here, the elbow coupling 208 can be used to aim/secure the air stream in some implementations. Additionally, the hose 210a can be secured with tie wraps or other fastening means, as shown by image 500B-2 in FIG. 5B.

### 2.5. Setpoint Configuration

FIG. 7 shows an example humidity controller configuration process 700 for configuring the controller 205 with a suitable humidity setpoint. Process 700 begins at operation 701 where the controller 205 is configured with a default RH value of X %. In one example, X equals 75, and thus, the default setpoint may be 75% RH. This default RH value may be a factory default or may be set by the user. In implementations where the controller 205 is a Climasys CC™ electronic hygrotherm, when the incubator is powered on, the controller 205 may have a default setpoint of 60% humidity, and thus, in these implementations X=60. Additionally, in these implementations, the controller 205 may be set to operate in operational mode M1. If mode M1 is not configured, a user may select “M1” using the arrow buttons 320-1, 320-3 on the controller 205 and confirm the selection of mode M1 by pressing the middle button 320-2. In other implementations, the user or automated mechanisms may interact with the controller 205 via suitable application programming interfaces (APIs), web services, middleware, and/or other interconnection mechanisms.

At operation 702, the controller 205 determines whether moisture problems inside the heated cabinet have been resolved. In some examples, this determination is based on the current humidity levels inside the heated cabinet, which may be measured using the humidity sensor(s) in the controller 205, and the measured humidity levels may be compared to a desired RH target Additionally or alternatively, this determination may be based on whether condensation is observed inside the heated cabinet. The observation of moisture issues can be performed manually by a human operator. Additionally or alternatively, the observation of moisture issues can be performed using image capture devices (e.g., visible light-based cameras and the like), infrared (IR) sensors (including near IR, mid IR, and/or the like), humidity sensors, dew point sensors, conductive condensation sensors, thermal conductivity sensors, and/or other types of sensors or devices to detect moisture and/or condensation. These implementations can be performed automatically or autonomously, or with the assistance of human operators.

If moisture problems inside the heated cabinet have not been resolved, the controller 205 proceeds to operation 703 to reduce the setpoint by a predetermined or configurable amount, which is denoted as Y % in FIG. 7. In one example, Y equals 5, and thus, the setpoint may be reduced by 5% RH. In another example, Y equals 3, and thus, the setpoint may be reduced by 3% RH. Other values may be predefined or configured in other implementations. The reduction of the setpoint can be done manually by a human operator, or may be performed autonomously by the controller 205. In implementations where the controller 205 is a Climasys CC™ electronic hygrotherm, the setpoint may be adjusted by pressing the up button 320-1 or down button 320-3 when the current setpoint is shown on the display 330 to get to the desired setpoint. The desired setpoint may be saved or configured by pressing the middle button 320-2.

After the setpoint is reduced, the controller 205 proceeds to operation 704 to determine if a predetermined or configurable number of configuration periods have been reached. In one example, the number of configuration periods may be three periods, however, any number of configuration periods may be used. If the number of configuration periods have not been reached, the controller 205 proceeds back to operation 702 to determine whether the moisture problems have been resolved. If the number of configuration periods have been reached, the controller 205 proceeds to operation 705 to have the cabinet serviced or perform further investigation into the causes of the moisture issues. Process 700 may end before or after operation 705 is performed.

If at operation 702 the moisture problems have been resolved, the controller 205 proceeds to operation 706 to monitor moisture levels inside the cabinet for a predetermined or configurable period of time. In some examples, this period of time can be 1 week. However, this period of time may be use-case specific and/or cabinet type-dependent. After the monitoring period has ended. At operation 707, the controller 205 determines whether the monitoring period has ended, and if not, the controller 205 loops back to operation 706 to continue monitoring the moisture levels inside the cabinet.

If the monitoring period has ended, the controller 205 proceeds to operation 908 to determine whether the moisture problems are still resolved or not. This determination may be performed in a same or similar manner as discussed previously with respect to operation 702. If the moisture problems are still resolved, the setpoint is maintained at operation 909 and the process 700 ends. If the moisture problems are not resolved at operation 908, the controller 205 proceeds back to operation 701 to repeat process 700.

### 2.6. Humidity Control System Operation

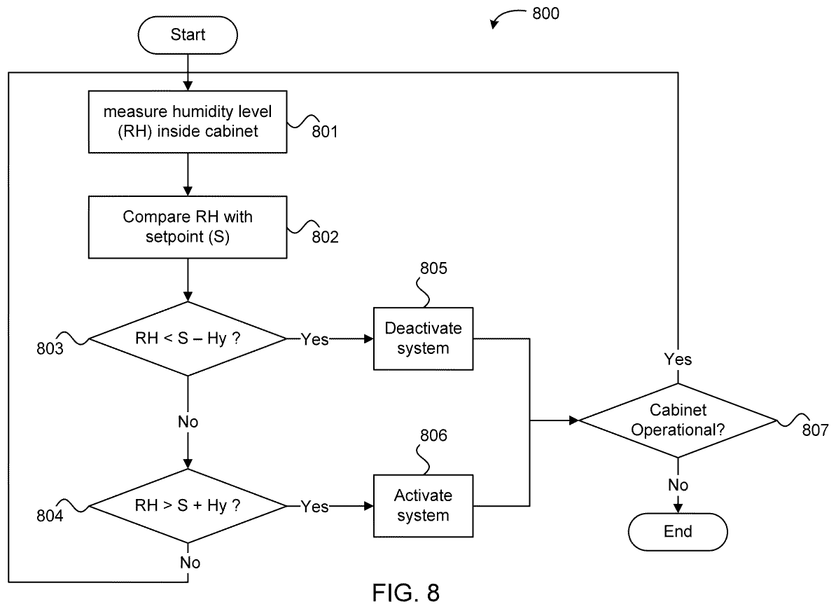

FIG. 8 shows an example humidity control process 800 during operation of a heated cabinet, such an incubator 100. Process 800 may be performed by controller 205 of humidity control system 200 after being installed in the heated cabinet and configured using, for example, the configuration process 700 of FIG. 7.

Process 800 begins after initialization of the humidity control system 200, where at operation 801 the controller 205 measures the current humidity level (e.g., a % RH value) inside the heated cabinet using the humidity sensor(s) in (or accessible by) the controller 205. At operation 802, the controller 205 compares the measured humidity level (RH) with the configured setpoint(S) at operation 802. Next, the controller 205 proceeds to perform operations 803 to 807, which may represent a hysteresis check.

At operation 803, the controller 205 determines whether the measured humidity level (RH) is below the setpoint(S) minus a predefined or configured hysteresis value (Hy) (e.g., 3%, 5%, or the like). If the RH is below the S minus the Hy, then the RH may be considered to be too low. Therefore, the controller 205 proceeds, at operation 805, to deactivate the humidity control system 200 to increase the RH inside the cabinet by, for example, by controlling the pneumatic valve 203 to prevent gas flowing into the heated cabinet.

If at operation 803 the RH is not below the S minus the Hy, then the controller 205 proceeds to operation 804 to determine whether the RH is above the S plus the Hy. If the RH is above the S plus the Hy, then the RH may be considered to be too high. Therefore, the controller 205 proceeds, at operation 806, to activate the humidity control system 200 to decrease the RH inside the cabinet by, for example, controlling the pneumatic valve 203 to allow gas to flow into the heated cabinet. If the RH is not above the S plus the Hy, then the measured RH is likely within the hysteresis range, and thus, the controller 205 maintains the current state (e.g., pneumatic valve 203 in either the “on” or “off” state) and returns back to operation 801 to continue monitoring the humidity levels inside the cabinet.

The Hy used in operation 803 may be a first hysteresis value, and the Hy used in operation 804 may be a second hysteresis value. In some implementations, the first hysteresis value may be the same as the second hysteresis value. For example, the first and second hysteresis values may be 3%, 5%, or some other value/percentage. In other implementations, the first hysteresis value may be different than the second hysteresis value. For example, the first hysteresis value may be 3% or some other value/percentage, and the second hysteresis value may be 5% or some other value/percentage. In either of the aforementioned implementations, the hysteresis values can be dynamically changed. For example, the humidity controller 205 may offer programmable settings that allow users to define custom hysteresis values that correspond to specified conditions or application requirements. In these implementations, a user can input desired hysteresis values and their corresponding conditions/requirements via a suitable programming interface or using input device(s) 320. In another example, the hysteresis values can be based on an adaptive control algorithm, which automatically adjusts the hysteresis values based on real-time data from continuously monitored environmental conditions. In these implementations, the adaptive control algorithm may analyze trends in the RH levels, account for variations in environmental factors, and dynamically optimize the hysteresis values to maintain the configured setpoint accuracy while minimizing overshoot or oscillations.

After performance of operation 805 or 806, the controller 205 proceeds to operation 807 to determine whether the heated cabinet is still operational (e.g., whether the cabinet is still “on”). For example, when the heated cabinet is an incubator 100, the controller 205 may determine whether the XYR manipulator is currently active, or is moving containers/plates to/from the CSA 108. If the cabinet is still operational, the controller 205 proceeds back to operation 801 to monitor the RH inside the cabinet. If the cabinet is no longer operational, process 800 ends.

### 3. Additional Remarks

For the purposes of the present disclosure, the singular forms “a,” “an” and “the” are intended to include plural forms as well, unless the context clearly indicates otherwise. The terms “comprises” and/or “comprising,” when used herein, specify the presence of stated features, integers, steps, operations, elements, and/or components, but do not preclude the presence or addition of one or more other features, integers, steps, operations, elements, components, and/or groups and/or combinations thereof. Additionally, the phrase “A and/or B” means (A), (B), or (A and B), and the phrase “A, B, and/or C” means (A), (B), (C), (A and B), (A and C), (B and C), or (A, B and C). The phrase “X(s)” means one or more X, a set of X, or a plurality of X. As used herein, the term “each” refers to each member of a set or each member of a subset of a set. The phrases “in an embodiment,” “In some embodiments,” “in one implementation,” “In some implementations,” “in some examples”, and other similar phrases used herein may refer to one or more of the same or different embodiments, implementations, and/or examples. Furthermore, the terms “comprising,” “including,” “having,” and the like, as used with respect to the present disclosure, may be synonymous.

Unless otherwise specifically noted, articles depicted in the drawings are not necessarily drawn to scale. In the appended drawings, which are not necessarily drawn to scale, like numerals may describe similar components in different views. Like numerals having different letter suffixes may represent different instances of similar components.

From the foregoing and with reference to the various drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Additionally, although exemplary embodiments are illustrated in the figures and described herein, the principles of the present disclosure may be implemented using any number of techniques, whether currently known or not. The present disclosure should in no way be limited to the exemplary implementations and techniques illustrated in the drawings and described herein.

Those skilled in the art will envision other modifications within the scope and spirit of the claims appended hereto. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, various steps or operations may be performed in any suitable order.

Although specific advantages have been enumerated above, various embodiments may include some, none, or all of the enumerated advantages. Other technical advantages may become readily apparent to one of ordinary skill in the art after review of the figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. A humidity control system deployed in an enclosure, the system comprising:
a pneumatic valve pneumatically connected to an interior of the enclosure; and
a humidity controller electrically connected to the pneumatic valve, wherein the humidity controller is to:
receive sensor data representative of a measured relative humidity (RH) level inside the enclosure;
cause the pneumatic valve to allow gas to flow into the enclosure when the measured RH level is above a configured setpoint; and
cause the pneumatic valve to prevent gas from flowing into the enclosure when the measured RH level is below the configured setpoint.

2. The system of claim 1, wherein the pneumatic valve is pneumatically connected to an interior of the enclosure via a first pneumatic connection.

3. The system of claim 2, wherein the first pneumatic connection comprises a flow control device and a pneumatic tube.

4. The system of claim 3, wherein the pneumatic valve is directly coupled with the flow control device via a first connector of the flow control device, and the flow control device is directly coupled with an end of the pneumatic tube via a second connector of the flow control device.

5. The system of claim 4, wherein the first connector of the flow control device is a male fastener configured to be received by a first female port of the pneumatic valve, and the second connector of the flow control device is a female port configured to receive a male connector on the end of the pneumatic tube.

6. The system of any one of claims 4 to 5, wherein another end of the pneumatic tube is connected to a pneumatic fitting.

7. The system of claim 6, wherein the pneumatic fitting is an L-shaped connector.

8. The system of any one of claims 6 to 7, wherein a first port of the pneumatic fitting is connected to the other end of the pneumatic tube, and a second port of the pneumatic fitting is connected to a pneumatic silencer.

9. The system of any one of claims 6 to 8, wherein the other end of the pneumatic tube is aimed at a heating element inside the enclosure such that the gas flowing into the enclosure is directed towards the heating element to provide a drying effect.

10. The system of any one of claims 6 to 9, wherein the other end of the pneumatic tube is aimed at one or more fans inside the enclosure such that the gas flowing into the enclosure is directed towards the one or more fans to circulate the gas throughout an interior of the enclosure.

11. The system of any one of claims 4 to 10, wherein the pneumatic valve is pneumatically connected to a gas source via a second pneumatic connection.

12. The system of claim 11, wherein the pneumatic tube is a first pneumatic tube, and the second pneumatic connection comprises an air coupling and a second pneumatic tube.

13. The system of claim 12, wherein the pneumatic valve is directly coupled with the air coupling via a first connector of the air coupling, and the air coupling is directly coupled with an end of the second pneumatic tube via a second connector of the air coupling.

14. The system of claim 13, wherein the first connector of the air coupling is a male fastener configured to be received by a second female port of the pneumatic valve, and the second connector of the air coupling is a female port configured to receive a male connector on the end of the second pneumatic tube.

15. The system of claim 14, wherein the air coupling is an L-shaped connector.

16. The system of any one of claims 14 to 15, wherein another end of the second pneumatic tube is connected to another pneumatic fitting.

17. The system of claim 16, wherein the other pneumatic fitting is a Y-shaped connector.

18. The system of claim 17, wherein a first connector of the other pneumatic fitting is connected to the other end of the second pneumatic tube, and a second port of the other pneumatic fitting is connected to the gas source.

19. The system of claim 18, wherein the other pneumatic fitting is connected to the gas source via a third pneumatic tube.

20. The system of any one of claims 18 to 19, wherein a third port of the other pneumatic fitting is connected one or more pneumatic actuators via a fourth pneumatic tube.

21. The system of claim 20, wherein the one or more pneumatic actuators are configured to move an XYR manipulator.

22. The system of any one of claims 11 to 21, wherein the gas source is an air compressor.

23. The system of claim 22, wherein the air compressor is configured to supply air according to ISO 8573-1:2010 [4:4:4] or ISO 8573-1:2010 [1:7:2].

24. The system of any one of claims 11 to 21, wherein the gas source is a gas tank, and the gas tank includes at least one gas selected from a group comprising: air, oxygen, carbon dioxide, nitrogen, argon, helium, hydrogen, or a specialty gas.

25. The system of any one of claims 1 to 23, wherein the humidity controller is to:
cause the pneumatic valve to allow gas to flow into the enclosure only when the measured RH level is greater than the configured setpoint plus a hysteresis value.

26. The system of any one of claims 1 to 25, wherein the humidity controller is to:
cause the pneumatic valve to prevent gas from flowing into the enclosure when the measured RH level is below the configured setpoint minus a hysteresis value.

27. The system of any one of claims 1 to 26, wherein the humidity controller is to:
configure the setpoint by continuous reduction of the setpoint by a value until moisture issues are no longer observed within the enclosure.

28. The system of any one of claims 1 to 27, wherein the humidity controller is to:
receive the sensor data representative of the measured RH level from one or more humidity sensors inside the enclosure.

29. The system of claim 28, wherein at least one of the one or more humidity sensors are embedded in the humidity controller.

30. The system of any one of claims 28 to 29, wherein at least one of the one or more humidity sensors are external to the humidity controller and mounted inside the enclosure separate from the humidity controller.

31. The system of any one of claims 1 to 30, wherein the pneumatic valve includes a valve closure element.

32. The system of claim 31, wherein, to cause the pneumatic valve to allow gas to flow into the enclosure, the humidity controller is to:
send a signal to the pneumatic valve to open the valve closure element.

33. The system of any one of claims 31 to 32, wherein, to cause the pneumatic valve to prevent gas from flowing into the enclosure, the humidity controller is to:
send a signal to the pneumatic valve to close the valve closure element.

34. The system of any one of claims 1 to 33, further comprising:
a bracket on which the pneumatic valve and the humidity controller are configured to be mounted.

35. The system of claim 34, wherein the bracket is configured to be mounted on an inside wall of the enclosure.

36. The system of any one of claims 1 to 35, wherein the humidity controller is a hygrostat or a hygrotherm.

37. The system of any one of claims 1 to 36, wherein the enclosure is an incubator, a food warming cabinet, an industrial heating cabinet, a moisture control cabinet, medical instrument sterilization cabinet, a controlled atmosphere chamber, a glove box, a paint drying cabinet, a curing oven used for semiconductor manufacturing, or an annealing oven used for semiconductor manufacturing.

38. A method of operating a humidity controller of a humidity control system deployed in an enclosure, the method comprising:
receiving, from at least one humidity sensor, sensor data representative of a measured relative humidity (RH) level inside the enclosure;
causing a pneumatic valve connected to the humidity controller to allow gas to flow into the enclosure when the measured RH level is above a configured setpoint; and
causing the pneumatic valve to prevent gas from flowing into the enclosure when the measured RH level is below the configured setpoint.

39. The method of claim 38, wherein the pneumatic valve is pneumatically connected to an interior of the enclosure.

40. The method of any one of claims 38 to 39, further comprising:
causing the pneumatic valve to allow gas to flow into the enclosure only when the measured RH level is greater than the configured setpoint plus a hysteresis value.

41. The method of claim 40, wherein the hysteresis value is a first hysteresis value, and the method further comprises:
causing the pneumatic valve to prevent gas from flowing into the enclosure when the measured RH level is below the configured setpoint minus a second hysteresis value.

42. The method of claim 41, wherein the first hysteresis value is same as the second hysteresis value.

43. The method of claim 41, wherein the first hysteresis value is different than the second hysteresis value.

44. The method of any one of claims 38 to 43, further comprising:
configuring the setpoint by continuous reduction of the setpoint by a value until a desired moisture abatement is observed within the enclosure.

45. The method of any one of claims 38 to 44, wherein the at least one humidity sensor is embedded in the humidity controller.

46. The method of any one of claims 38 to 44, wherein the at least one humidity sensor is external to the humidity controller and mounted inside the enclosure separate from the humidity controller.

47. The method of any one of claims 38 to 46, wherein the pneumatic valve includes a valve closure element.

48. The method of claim 47, wherein causing the pneumatic valve to allow gas to flow into the enclosure, the humidity controller comprises:
sending a first signal to the pneumatic valve, wherein the first signal instructs the pneumatic valve to open the valve closure element.

49. The method of any one of claims 47 to 48, wherein causing the pneumatic valve to prevent gas from flowing into the enclosure comprises:
sending a second signal to the pneumatic valve, wherein the second signal instructs the pneumatic valve to close the valve closure element.

50. At least one computer-readable storage media comprising instructions, wherein execution of the instructions by one or more processors of a humidity controller is to cause the humidity controller to perform the method of any one of claims 38 to 49.
